(19) United States
(12) Patent Application Publication
(10) Pub. No.: US 2014/0233639 A1
(43) Pub. Date: Aug. 21, 2014

(54) IMAGE PROCESSING DEVICE AND METHOD

(71) Applicant: SONY CORPORATION, Minato-ku (JP)

(72) Inventor: Kazushi Sato, Kanagawa (JP)

(73) Assignee: SONY CORPORATION, Minato-ku (JP)

(21) Appl. No.: 14/343,970

(22) PCT Filed: Oct. 5, 2012
(86) PCT No.: PCT/JP2012/075922

§ 371 Date: Mar. 10, 2014

(30) Foreign Application Priority Data
Oct. 14, 2011 (JP) 2011-227023

(51) Int. Cl. H04N 19/139; H04N 19/17; H04N 19/159; H04N 19/105

(52) U.S. Cl. CPC H04N 19/00151; H04N 19/00024; H04N 19/0026; H04N 19/00218
USPC 375/240.03

(57) ABSTRACT

Disclosed is an image processing device and method capable of improving encoding efficiency when encoding motion vectors. A motion vector encoding unit generates (determines) a predictive motion vector of each PU. A region deciding unit refers to a predictive motion vector of a current PU_{C} and predictive motion vectors of respective adjacent PUs adjacent to the current PU_{C} to determine a CU_{T}, to which an adjacent PU_{T} having the same predictive motion vector as the current PU_{C} belongs, as a region referred to for generating a predictive quantization parameter of the current CU_{T}. This disclosure can be applied to an image processing device, for example.

### TECHNICAL FIELD

This disclosure relates to an image processing device and method. Specifically, this disclosure relates to an image processing device and method capable of improving encoding efficiency.

### BACKGROUND ART

In recent years, devices for compressing and encoding an image according to an encoding scheme which handles image information as digital data, which, in this case, aims to transmit and store information with high efficiency, and which compresses the image information according to orthogonal transform such as discrete cosine transform and motion compensation by utilizing redundancy that is unique to the image information have become widespread. Examples of this encoding scheme include MPEG (Moving Picture Experts Group) and the like.

In particular, MPEG2 (ISO/IEC 13818-2) is defined as a general-purpose image encoding scheme and is a standard encompassing both of interlaced scanning images and sequential scanning images, and standard resolution images and high definition images. For example, MPEG2 is presently widely used in a wide range of applications for professional and consumer usages. By employing the MPEG2 compression scheme, a code amount (bit rate) of 4 to 8 Mbps is allocated for an interlaced scanning image of standard resolution having 720×480 pixels, for example. By employing the MPEG2 compression scheme, a code amount (bit rate) of 18 to 22 Mbps is allocated for an interlaced scanning image of high resolution having 1920×1088 pixels, for example. As a result, a high compression rate and good image quality can be realized.

The MPEG2 has been mainly intended for high-image-quality encoding appropriate for broadcasting, but was not compatible with an encoding scheme for realizing a lower code amount (bit rate) (a higher compression ratio) than that of MPEG1. With the popularity of mobile terminals, the demand for such an encoding scheme is expected to increase in the future. To respond this, standardization of MPEG4 encoding schemes have been confirmed. With regard to an image encoding scheme, the specification thereof was confirmed as the international standard ISO/IEC 14496-2 in December in 1998.

The schedule of standardization showed that, it became an international standard under the name of H.264 and MPEG-4 Part 10 (Advanced Video Coding, hereinafter referred to as H.264/AVC) in March, 2003.

Further, as an extension of H.264/AVC, standardization of FRExt (Fidelity Range Extension), which includes encoding tools necessary for operations such as RGB, 4:2:2, 4:4:4, and MPEG-2 stipulated 8×8DCT and quantization matrices, has been completed in February, 2005. Accordingly, an encoding scheme capable of satisfactorily expressing film noise included in movies using H.264/AVC was obtained, and is to be used in a wide range of applications such as Blu-Ray Disc (Registered Trademark).

However, recently, there are increased needs for further higher compression encoding, such as to compress images of 4000×2000 pixels which is four times that of high-vision images, or such as to distribute high-vision images in an environment with limited transmission capacity, such as the Internet. Accordingly, the VCEG (=Video Coding Expert Group) under ITU-T described above is continuing study relating to improvement of encoding efficiency.

As one method of improving encoding efficiency, in order to improve encoding of motion vectors using median prediction defined in the AVC scheme, a method that allows any one of “temporal predictor” and “spatio-temporal predictor” to be adaptively used as predictive motion vector information in addition to “spatial predictor” obtained in the median prediction (hereinafter, this adaptive use is also referred to as MV competition) has been proposed (for example, see Non-Patent Document 1).

In the AVC scheme, when predictive motion vector information is selected, a cost function value based on a high complexity mode or a low complexity mode implemented in reference software of AVC called a joint model (JM) is used.

That is, the cost function value when the predictive motion vector information is used is calculated and optimal predictive motion vector information is selected. In image compression information, flag information indicating information on predictive motion vector information being used is transmitted.

However, setting the size of a macroblock to 16×16 pixels is not optimal for a large image frame named UHD (Ultra High Definition; 4000×2000 pixels) that will become an object of the next generation encoding scheme.

Thus, the standardization of an encoding system called HEVC (High Efficiency Video Coding) has been currently developed by JCTVC (Joint Collaboration Team-Video Coding), which is a joint standardization organization of ITU-T and ISO/IEC, for the purpose of further improving the encoding efficiency as compared to AVC (for example, see Non-Patent Document 2).

In the HEVC encoding scheme, a coding unit (CU) is defined as the same processing unit as the macroblock in the AVC scheme. The size of CU is not fixed to 16×16 pixels unlike the macroblock of the AVC scheme but is designated in image compression information in respective sequences. Moreover, in the respective sequences, the largest size (LCU: Largest Coding Unit) and the smallest size (SCU: Smallest Coding Unit) of the CU are defined.

Further, in Non-Patent Document 2, a quantization parameter QP can be transmitted in sub-LCUs. The size of coding units in which quantization parameters are transmitted is designated in the image compression information of each picture. Moreover, the information on quantization parameters, included in the image compression information is transmitted in the respective coding units.

Moreover, a method (hereinafter also referred to as merge mode) called motion partition merging is proposed as one of encoding schemes for motion information (for example, see Non-Patent Document 3). In this method, when the motion information of a current block is the same as the motion information of a neighboring block, only flag information is transmitted. During decoding, the motion information of the current block is reconstructed using the motion information of the neighboring block.

However, in the above-described MV competition or merge mode, since the temporal predictor realizes higher encoding efficiency in a still image region in particular, a tendency that the temporal predictor is more likely to be selected when selecting a predictor based on a cost function value in the still image region is observed.

### CITATION LIST

### Non-Patent Document

Non-Patent Document 1: Joel Jung, Guillaume Laroche, “Competition-Based Scheme for Motion Vector Selection and Coding”, VCEG-AC06, ITU—Telecommunications Standardization Sector STUDY GROUP 16 Question 6 Video Coding Experts Group (VCEG) 29th Meeting: Klagenfurt, Austria, 17-18 July, 2006
Non-Patent Document 2: Thomas Wiegand, Woo-Jin Han, Benjamin Bross, Jens-Rainer Ohm, Gary J. Sullivan, “Working Draft 4 of High-Efficiency Video Coding”, JCTVC-F803, Joint Collaborative Team on Video Coding (JCT-VC) of ITU-T SG16 WP3 and ISO/IEC JTC1/SC29/WG11 6th Meeting: Torino, IT, 14-22 July, 2011
Non-Patent Document 3: Martin Winken, Sebastian Bosse, Benjamin Bross, Philipp Helle, Tobias Hinz, Heiner Kirchhoffer, Haricharan Lakshman, Detlev Marpe, Simon Oudin, Matthias Preiss, Heiko Schwarz, Mischa Siekmann, Karsten Suchring, and Thomas Wiegand, “Description of video coding technology proposed by Fraunhofer HHI”, JCTVC-A116, April, 2010

### SUMMARY OF THE INVENTION

### Problems to be Solved by the Invention

Here, in inter-slices, a case in which a spatial predictor is selected in a current CU and a temporal predictor is selected in a left neighboring CU of the current block, or the opposite case will be taken into considered. In this case, according to the predictive encoding scheme of quantization parameters disclosed in Non-Patent Document 2, since quantization parameters are encoded between different regions of a still region and a moving region, prediction efficiency may decrease.

This disclosure is made in view of the situations, and aims to improve encoding efficiency when encoding quantization parameters.

### Solutions to Problems

According to a first aspect of this disclosure, there is provided an image processing device including: a predictive motion vector generating unit that generates a predictive motion vector used when decoding a motion vector of a current region using a motion vector of a neighboring region located around the current region; a predictive quantization parameter generating unit that generates a predictive quantization parameter used when decoding a quantization parameter of the current region according to a method of predicting the predictive motion vector of the neighboring region, generated by the predictive motion vector generating unit; and a parameter decoding unit that decodes the motion vector of the current region using the predictive motion vector of the current region generated by the predictive motion vector generating unit and decodes the quantization parameter of the current region using the predictive quantization parameter of the current region generated by the predictive quantization parameter generating unit.

The predictive quantization parameter generating unit may generate the predictive quantization parameter of the current region depending on whether the method of predicting the predictive motion vector of the neighboring region is spatial prediction or temporal prediction.

The predictive quantization parameter generating unit may generate the predictive quantization parameter of the current region depending on whether a position of a reference region referred to for the spatial prediction is TOP or Left when the method of predicting the predictive motion vector of the neighboring region is spatial prediction.

The predictive quantization parameter generating unit may generate the predictive quantization parameter of the current region using the predictive quantization parameter of the neighboring region generated according to the same prediction method as the prediction method of predicting the predictive motion vector of the current region.

When the region is made up of a plurality of sub-regions, the predictive quantization parameter generating unit may generate, as a target of the adjacent region, the predictive quantization parameter of the current region using a predictive motion vector of a sub-region of the neighboring region, located adjacent to a top-left sub-region located at a top left corner of the current region.

When the region is made up of a plurality of sub-regions, the predictive quantization parameter generating unit may generate, as a target of the adjacent region, the predictive quantization parameter of the current region using a predictive motion vector of a top sub-region of the neighboring region, located adjacent to the top of the current region and a predictive motion vector of a left sub-region of the neighboring region, located adjacent to the left of the current region.

When bi-predictive prediction is applied to the neighboring region, the predictive quantization parameter generating unit may generate the predictive quantization parameter of the current region according to a method of predicting a predictive motion vector with respect to List0 prediction, of the neighboring region.

When bi-predictive prediction is applied to the neighboring region, the predictive quantization parameter generating unit may generate the predictive quantization parameter of the current region according to a method of predicting a predictive motion vector with respect to a List0 prediction, of the neighboring region when a current picture is not reordered and may generate the predictive quantization parameter of the current region according to a method of predicting a predictive motion vector with respect to List1 prediction, of the neighboring region when the current picture is reordered.

When bi-predictive prediction is applied to the neighboring region, the predictive quantization parameter generating unit may generate the predictive quantization parameter of the current region according to a method of predicting a predictive motion vector with respect to prediction of a closer distance on a time axis, of the neighboring region.

The predictive quantization parameter generating unit may generate the predictive quantization parameter of the current region according to a prediction direction of the predictive motion vector of the neighboring region and a prediction direction of the predictive motion vector of the current region.

The image processing device may further include a decoding unit that decodes a bit stream using the motion vector and the quantization parameter decoded by the parameter decoding unit.

The bit stream is encoded in units having a layer structure and the decoding unit decodes the bit stream in units having a layer structure.

According to the first aspect of this disclosure, there is provided an image processing method for causing an image processing device to execute: generating a predictive motion vector used when decoding a motion vector of a current region using a motion vector of a neighboring region located around the current region; generating a predictive quantization parameter used when decoding a quantization parameter of the current region according to a method of predicting the generated predictive motion vector of the neighboring region; and decoding the motion vector of the current region using the generated predictive motion vector of the current region and decoding the quantization parameter of the current region using the generated predictive quantization parameter of the current region.

According to a second aspect of this disclosure, there is provided an image processing device including: a predictive motion vector generating unit that generates a predictive motion vector used when encoding a motion vector of a current region using a motion vector of a neighboring region located around the current region; a predictive quantization parameter generating unit that generates a predictive quantization parameter used when encoding a quantization parameter of the current region according to a method of predicting the predictive motion vector of the neighboring region, generated by the predictive motion vector generating unit; and a parameter encoding unit that encodes the motion vector of the current region using the predictive motion vector of the current region generated by the predictive motion vector generating unit and encodes the quantization parameter of the current region using the predictive quantization parameter of the current region generated by the predictive quantization parameter generating unit.

The predictive quantization parameter generating unit may generate the predictive quantization parameter of the current region depending on whether the method of predicting the predictive motion vector of the neighboring region is spatial prediction or temporal prediction.

The predictive quantization parameter generating unit may generate the predictive quantization parameter of the current region using the predictive quantization parameter of the neighboring region generated according to the same prediction method as the prediction method of predicting the predictive motion vector of the current region.

The predictive quantization parameter generating unit may generate the predictive quantization parameter of the current region according to a prediction direction of the predictive motion vector of the neighboring region and a prediction direction of the predictive motion vector of the target region.

The image processing device may further include: a transmission unit that encodes an image using the motion vector of the current region and the quantization parameter of the current region to generate a bit stream and transmits the motion vector and the quantization parameter encoded by the parameter encoding unit together with the bit stream generated by the encoding unit.

The encoding unit may encode the image in units having a layer structure to generate the bit stream.

According to the second aspect of this disclosure, there is provided an image processing method for causing an image processing device to execute: generating a predictive motion vector used when encoding a motion vector of a current region using a motion vector of a neighboring region located around the current region; generating a predictive quantization parameter used when encoding a quantization parameter of the current region according to a method of predicting the generated predictive motion vector of the neighboring region; and encoding the motion vector of the current region using the generated predictive motion vector of the current region and encoding the quantization parameter of the current region using the generated predictive quantization parameter of the current region.

In an aspect of this disclosure, a predictive motion vector used when decoding a motion vector of a current region is generated using a motion vector of a neighboring region located around the current region, and a predictive quantization parameter used when decoding a quantization parameter of the current region is generated according to a method of predicting the generated predictive motion vector of the neighboring region. Moreover, the motion vector of the current region is decoded using the generated predictive motion vector of the current region, and the quantization parameter of the current region is decoded using the generated predictive quantization parameter of the current region.

In another aspect of this disclosure, a predictive motion vector used when encoding a motion vector of a current region is generated using a motion vector of a neighboring region located around the current region, and a predictive quantization parameter used when encoding a quantization parameter of the current region is generated according to a method of predicting the generated predictive motion vector of the neighboring region. Moreover, the motion vector of the current region is encoded using the generated predictive motion vector of the current region, and the quantization parameter of the current region is encoded using the generated predictive quantization parameter of the current region.

The image processing device described above may be an independent device and may be an internal block that constitutes one image encoding device or image decoding device.

### Effects of the Invention

According to an aspect of this disclosure, it is possible to decode images. In particular, it is possible to improve the encoding efficiency.

According to another aspect of this disclosure, it is possible to encode images. In particular, it is possible to improve the encoding efficiency.

### BRIEF DESCRIPTION OF THE DRAWINGS

FIG. 1 is a block diagram illustrating an example of main components of an image encoding device.

FIG. 2 is a diagram illustrating an example of a fractional pixel precision motion prediction/compensation process.

FIG. 3 is a diagram illustrating an example of a macroblock.

FIG. 4 is a diagram for describing a median operation.

FIG. 5 is a diagram for describing a multi-reference frame.

FIG. 6 is a diagram for describing a temporal direct mode.

FIG. 7 is a diagram for describing a motion vector encoding method.

FIG. 8 is a diagram for describing a configuration example of a coding unit.

FIG. 9 is a diagram illustrating an example of syntax elements of a picture parameter set.

FIG. 10 is a diagram illustrating an example of syntax elements of transform_coeff.

FIG. 11 is a diagram for describing motion partition merging.

FIG. 12 is a diagram for describing a predictive motion vector in a still region.

FIG. 13 is a diagram for describing a quantization parameter prediction method according to this technique.

FIG. 14 is a diagram for describing another quantization parameter prediction method.

FIG. 15 is a diagram for describing a quantization parameter prediction method in the case of bi-predictive prediction.

FIG. 16 is a block diagram illustrating an example of main components of a motion vector encoding unit, a region determining unit, and a quantization unit.

FIG. 17 is a flowchart for describing an example of the flow of an encoding process.

FIG. 18 is a flowchart for describing an example of the flow of a parameter generating process.

FIG. 19 is a block diagram illustrating an example of main components of an image decoding device.

FIG. 20 is a block diagram illustrating an example of main components of a motion vector encoding unit, a region determining unit, and an inverse quantization unit.

FIG. 21 is a flowchart for describing an example of the flow of a decoding process.

FIG. 22 is a flowchart for describing an example of the flow of a parameter reconstructing process.

FIG. 23 is a diagram illustrating an example of a multi-view image encoding scheme.

FIG. 24 is a diagram illustrating an example of main components of a multi-view image encoding device to which the present technique is applied.

FIG. 25 is a diagram illustrating an example of main components of a multi-view image decoding device to which the present technique is applied.

FIG. 26 is a diagram illustrating an example of a layer image encoding scheme.

FIG. 27 is a diagram illustrating an example of main components of a layer image encoding device to which the present technique is applied.

FIG. 28 is a diagram illustrating an example of main components of a layer image decoding device to which the present technique is applied.

FIG. 29 is a block diagram illustrating an example of main components of a computer.

FIG. 30 is a block diagram illustrating an example of a schematic configuration of a television apparatus.

FIG. 31 is a block diagram illustrating an example of a schematic configuration of a mobile phone.

FIG. 32 is a block diagram illustrating an example of a schematic configuration of a recording/reproducing apparatus.

FIG. 33 is a block diagram illustrating an example of a schematic configuration of an imaging device.

### MODE FOR CARRYING OUT THE INVENTION

Hereinafter, modes for carrying out this disclosure (hereinafter referred to as embodiments) will be described. The description will be given in the following order:

1. First embodiment (image encoding device)
2. Second embodiment (image decoding device)
3. Third embodiment (multi-view image encoding and decoding device)
4. Fourth embodiment (layer image encoding and decoding device)
5. Fifth embodiment (computer)
6. Application example

### 1. First Embodiment

### Image Encoding Device

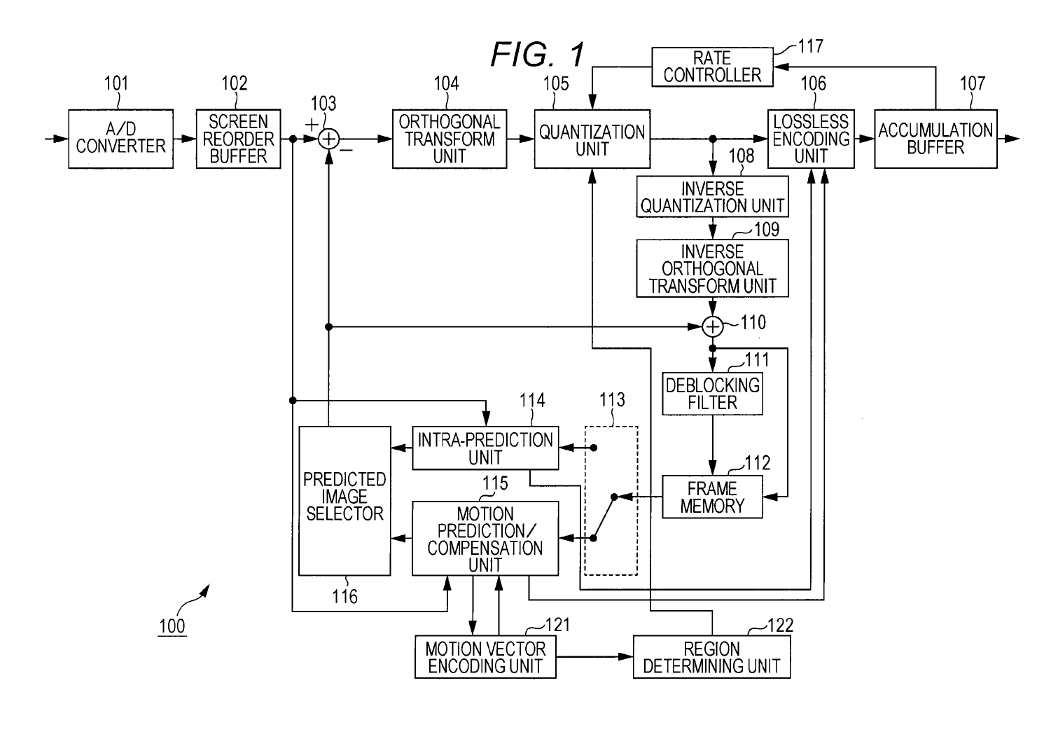

FIG. 1 is a block diagram illustrating an example of main components of an image encoding device.

An image encoding device 100 illustrated in FIG. 1 encodes image data using a prediction process according to a high efficiency video coding (HEVC) scheme, for example.

As illustrated in FIG. 1, the image encoding device 100 includes an A/D converter 101, a screen reorder buffer 102, an arithmetic unit 103, an orthogonal transform unit 104, a quantization unit 105, a lossless encoding unit 106, an accumulation buffer 107, an inverse quantization unit 108, and an inverse orthogonal transform unit 109. Moreover, the image encoding device 100 further includes an arithmetic unit 110, a deblocking filter 111, a frame memory 112, a selector 113, an intra-prediction unit 114, a motion prediction/compensation unit 115, a predicted image selector 116, and a rate controller 117.

The image encoding device 100 further includes a motion vector encoding unit 121 and a region determining unit 122.

The A/D converter 101 performs A/D conversion on the input image data, supplies the converted image data (digital data) to the screen reorder buffer 102, which stores the image data. The screen reorder buffer 102 reorders the frames of an image arranged in the stored order according to a GOP (Group Of Picture) so that the frames are reordered in the order for encoding to obtain an image in which the frame order is reordered and supplies the image to the arithmetic unit 103. The screen reorder buffer 102 supplies the image in which the frame order is reordered to the intra-prediction unit 114 and the motion prediction/compensation unit 115.

The arithmetic unit 103 subtracts a predicted image supplied from the intra-prediction unit 114 or the motion prediction/compensation unit 115 via the predicted image selector 116 from the image read from the screen reorder buffer 102 to obtain difference information thereof and outputs the difference information to the orthogonal transform unit 104.

Moreover, for example, in the case of an image which is subjected to inter-encoding, the arithmetic unit 103 subtracts the predicted image supplied from the motion prediction/compensation unit 115 from the image read from the screen reorder buffer 102.

The orthogonal transform unit 104 performs orthogonal transform such as discrete cosine transform or Karhunen-Loeve transform with respect to the difference information supplied from the arithmetic unit 103. The orthogonal transform method is optional. The orthogonal transform unit 104 supplies the transform coefficients to the quantization unit 105.

The quantization unit 105 quantizes the transform coefficients supplied from the orthogonal transform unit 104. The quantization unit 105 sets quantization parameters based on the information on a target code amount supplied from the rate controller 117 and performs quantization. The quantization method is optional. The quantization unit 105 supplies the quantized transform coefficients to the lossless encoding unit 106.

Moreover, the quantization unit 105 predicts a quantization parameter of a target region (also referred to as a current region) to be processed under the control of the region determining unit 122. Specifically, the quantization unit 105 generates a predictive quantization parameter of the target region under the control of the region determining unit 122 using a quantization parameter of a region spatially (within the picture) adjacent to the target region. The quantization unit 105 supplies the quantized transform coefficients to the lossless encoding unit 106 in order to encode a differential quantization parameter which is a difference between the quantization parameter of the target region and the predictive quantization parameter of the target region.

That is, the process of predicting the quantization parameter of the target region in the image encoding device 100 or an image decoding device 200 described later is performed in order to encode or decode the quantization parameter. Thus, the predictive quantization parameters are used for encoding or decoding the quantization parameters.

The adjacent region adjacent to the target region is also a neighboring region located around the target region, and it will be described that both terms mean the same region.

The lossless encoding unit 106 encodes the transform coefficients quantized by the quantization unit 105 according to an optional encoding scheme. Since coefficient data is quantized under the control of the rate controller 117, this code amount becomes (or approximates to) a target value set by the rate controller 117.

Moreover, the lossless encoding unit 106 acquires information that indicates an intra-prediction mode or the like from the intra-prediction unit 114 and acquires information that indicates an inter-prediction mode, differential motion vector information, and the like from the motion prediction/compensation unit 115. Further, the lossless encoding unit 106 acquires the differential quantization parameter from the quantization unit 105.

The lossless encoding unit 106 encodes these various types of information according to an optional encoding scheme and incorporates (multiplexes) the information as part of the header information of the encoded data. The lossless encoding unit 106 supplies the encoded data obtained by encoding to the accumulation buffer 107 which accumulates the encoded data.

Examples of the encoding scheme of the lossless encoding unit 106 include variable-length encoding and arithmetic encoding. An example of the variable-length encoding includes context-adaptive variable length coding (CAVLC) which is defined in the H.264/AVC scheme. An example of the arithmetic encoding includes context-adaptive binary arithmetic coding (CABAC).

The accumulation buffer 107 temporarily stores the encoded data supplied from the lossless encoding unit 106. The accumulation buffer 107 outputs the encoded data stored therein to a recording device (recording medium) (not illustrated), a transmission line, and the like in the subsequent stage, for example, at a predetermined timing.

Moreover, the transform coefficients quantized in the quantization unit 105 are also supplied to the inverse quantization unit 108. The inverse quantization unit 108 performs inverse quantization on the quantized transform coefficients according to a method corresponding to the quantization of the quantization unit 105. The inverse quantization method is optional as long as the method corresponds to the quantization process of the quantization unit 105. The inverse quantization unit 108 supplies the obtained transform coefficients to the inverse orthogonal transform unit 109.

The inverse orthogonal transform unit 109 performs inverse orthogonal transform on the transform coefficients supplied from the inverse quantization unit 108 according to a method corresponding to the orthogonal transform process of the orthogonal transform unit 104. The inverse orthogonal transform method is optional as long as the method corresponds to the orthogonal transform process of the orthogonal transform unit 104. The output (reconstructed difference information) obtained through the inverse orthogonal transform is supplied to the arithmetic unit 110.

The arithmetic unit 110 adds the predicted image supplied from the intra-prediction unit 114 or the motion prediction/compensation unit 115 via the predicted image selector 116 to the inverse orthogonal transform result (that is, the locally reconstructed difference information) supplied from the inverse orthogonal transform unit 109 to obtain a locally decoded image (decoded image). The decoded image is supplied to the deblocking filter 111 or the frame memory 112.

The deblocking filter 111 performs a deblocking filtering process appropriately with respect to the decoded image supplied from the arithmetic unit 110. For example, the deblocking filter 111 removes a block distortion of the decoded image by performing a deblocking filtering process on the decoded image.

The deblocking filter 111 supplies the filtering result (the decoded image after the filtering process) to the frame memory 112. As described above, the decoded image output from the arithmetic unit 110 may be supplied to the frame memory 112 without via the deblocking filter 111. That is, the filtering process of the deblocking filter 111 may not be performed.

The frame memory 112 stores the supplied decoded image and supplies the stored decoded image to the selector 113 as a reference image at a predetermined timing.

The selector 113 selects a supply destination of the reference image supplied from the frame memory 112. For example, in the case of inter-prediction, the selector 113 supplies the reference image supplied from the frame memory 112 to the motion prediction/compensation unit 115.

The intra-prediction unit 114 performs intra-prediction (intra-field prediction) that generates a predicted image basically using a prediction unit (PU) as a processing unit, using the pixel values in a processing target picture which is the reference image supplied from the frame memory 112 via the selector 113. The intra-prediction unit 114 performs the intra-prediction in a plurality of intra-prediction modes prepared in advance.

The intra-prediction unit 114 generates predicted images in all candidate intra-prediction modes, evaluates the cost function values of the respective predicted images using the input image supplied from the screen reorder buffer 102, and selects an optimal mode. When the optimal intra-prediction mode is selected, the intra-prediction unit 114 supplies the predicted image generated in the optimal mode to the predicted image selector 116.

As described above, the intra-prediction unit 114 supplies intra-prediction mode information that indicates the employed intra-prediction mode and the like to the lossless encoding unit 106 which encodes the information.

The motion prediction/compensation unit 115 performs motion prediction (inter-prediction) basically using PU as a processing unit, using the input image supplied from the screen reorder buffer 102 and the reference image supplied from the frame memory 112 via the selector 113. The motion prediction/compensation unit 115 supplies the detected motion vector to the motion vector encoding unit 121, performs a motion compensation process according to the detected motion vector, and generates a predicted image (inter-prediction image information). The motion prediction/compensation unit 115 performs such inter-prediction in a plurality of inter-prediction modes prepared in advance.

The motion prediction/compensation unit 115 generates predicted images in all candidate inter-prediction modes. The motion prediction/compensation unit 115 evaluates cost function values of the respective predicted images using the input image supplied from the screen reorder buffer 102, the optimal predictive motion vector information from the motion vector encoding unit 121, and the like and selects an optimal mode. When an optimal inter-prediction mode is selected, the motion prediction/compensation unit 115 supplies the predicted image generated in the optimal mode to the predicted image selector 116.

Moreover, the motion prediction/compensation unit 115 supplies information that indicates the employed inter-prediction mode and information necessary for performing processing in the inter-prediction mode when decoding the encoded data to the lossless encoding unit 106, which encodes the information. Examples of the necessary information include information on a differential motion vector which is a difference between a motion vector of a target region and a predictive motion vector of the target region, a flag indicating an index of a predictive motion vector as predictive motion vector information, and the like.

In the image encoding device 100 or the image decoding device 200 described later, the process of predicting the motion vector of the target region is performed in order to encode or decode the motion vector. Thus, the predictive motion vector is used for encoding or decoding the motion vector.

The predicted image selector 116 selects the source of the predicted image supplied to the arithmetic unit 103 and the arithmetic unit 110. For example, in the case of inter-encoding, the predicted image selector 116 selects the motion prediction/compensation unit 115 as the source of the predicted image and supplies the predicted image supplied from the motion prediction/compensation unit 115 to the arithmetic unit 103 and the arithmetic unit 110.

The rate controller 117 controls the rate of the quantization operation of the quantization unit 105 based on the code amount of the encoded data accumulated in the accumulation buffer 107 so that an overflow or an underflow does not occur.

The motion vector encoding unit 121 stores the motion vector obtained by the motion prediction/compensation unit 115. The motion vector encoding unit 121 predicts the motion vector of the target region. Specifically, the motion vector encoding unit 121 generates a predictive motion vector (predictor) of the target region using a motion vector of an adjacent region that is temporally or spatially adjacent to the target region. The motion vector encoding unit 121 supplies an optimal predictive motion vector that is the optimal among the generated predictive motion vectors to the motion prediction/compensation unit 115 and the region determining unit 122.

The region determining unit 122 stores the optimal predictive motion vector from the motion vector encoding unit 121. The region determining unit 122 determines an adjacent region of which the quantization parameter is to be referenced when generating a predictive quantization parameter of a target region with reference to a prediction method of a predictive motion vector of an adjacent region adjacent to the target region. The region determining unit 122 controls the predictive quantization parameter generating process of the quantization unit 105 based on the determination result.

That is, in the image encoding device 100 of FIG. 1, the quantization unit 105 generates the predictive quantization parameter of the target region according to the method of predicting the predictive motion vector of the adjacent region under the control of the region determining unit 122.

[¼ Pixel Precision Motion Prediction]

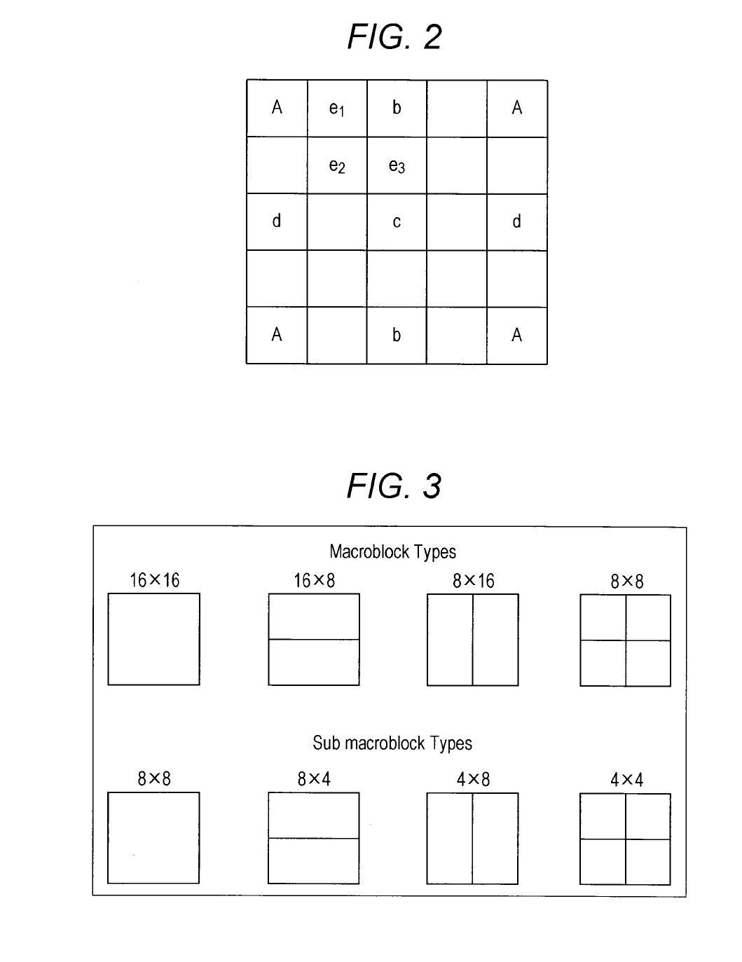

FIG. 2 is a diagram for describing an example of a ¼-pixel precision motion prediction/compensation process defined in the AVC scheme. In FIG. 2, each rectangle represents a pixel. Among the rectangles, A indicates the position of an integer precision pixel stored in the frame memory 112, b, c, and d indicate the positions having ½ pixel precision, and e1, e2, and e3 indicate the positions of ¼ pixel precision.

Hereinafter, a function Clip1( ) is defined as Expression (1) below.

$$\begin{matrix}[ Mathematical formula 1 ] & \\ Clip 1 ( a ) = \{ \begin{matrix}0 ; if ( a < 0 ) \\ a ; otherwise \\ max\_pix ; if ( a > max\_pix )\end{matrix} & ( 1 )\end{matrix}$$

For example, when an input image has 8-bit precision, the value of max_pix in Expression (1) is 255.

The pixel values at the positions b and d are generated according to Expressions (2) and (3) below using a 6-tap FIR filter.

[Mathematical formula 2]

F=A₋₂−5·A₋₁+20·A₀+20·A₁−5·A₂+A₃ (2)

[Mathematical formula 3]

b,d=Clip1((F+16)>>5) (3)

The pixel value at the position c is generated according to Expressions (4) to (6) below by applying a 6-tap FIR filter in the horizontal and vertical directions.

[Mathematical formula 4]

F=b₋₂−5·b₋₁+20·b₀+20·b₁−5·b₂+b₃ (4)

or

[Mathematical formula 5]

F=d₋₂−5·d₋₁+20·d₀+20·d₁−5·d₂+d₃ (5)

[Mathematical formula 6]

c=Clip1((F+512)>>10) (6)

The Clip process is lastly performed once after a product summing process is performed in both horizontal and vertical directions.

The pixel values at the positions e1 to e3 are generated by linear interpolation as in Expressions (7) to (9) below.

[Mathematical formula 7]

e₁=(A+b+1)>>1 (7)

[Mathematical formula 8]

e₂=(b+d+1)>>1 (8)

[Mathematical formula 9]

e₃=(b+c+1)>>1 (9)

### [Macroblock]

Moreover, in the MPEG2 scheme, the motion prediction/compensation process is performed in respective 16×16 pixels in the case of a frame motion compensation mode. Moreover, the motion prediction/compensation process is performed in respective 16×8 pixels for each of first and second fields in the case of a field motion compensation mode.

In contrast, in the AVC scheme, as illustrated in FIG. 3, one macroblock made up of 16×16 pixels can be divided into any one of partitions of 16×16 pixels, 16×8 pixels, 8×16 pixels, and 8×8 pixels so that sub-macroblocks have independent motion vector information. Further, as illustrated in FIG. 3, the 8×8 pixel partition can be divided into any one of sub-macroblocks made up of 8×8 pixels, 8×4 pixels, 4×8 pixels, and 4×4 pixels so that sub-macroblocks have independent motion vector information.

However, in the AVC scheme, when the motion prediction/compensation process is performed in a manner similarly to the MPEG2 scheme, a large amount of motion vector information may be generated. Thus, encoding the generated motion vector information as it was may result in a decrease in the encoding efficiency.

### [Median Prediction of Motion Vector]

As a method of solving such a problem, in the AVC scheme, encoding information of the motion vector is reduced according to the following method.

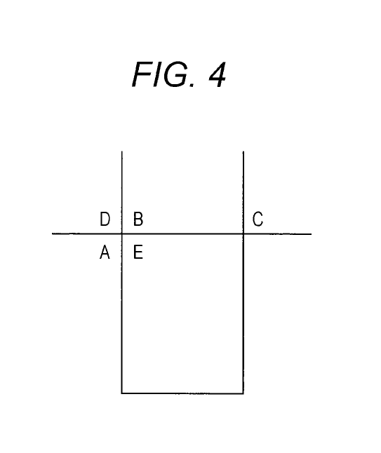

The lines illustrated in FIG. 4 represent the boundaries of motion compensation blocks. Moreover, in FIG. 4, E represents a current motion compensation block that is to be encoded from now on, and A to D represent motion compensation blocks adjacent to the block E, which have been encoded.

Now, with X=A, B, C, D, and E, the motion vector information for X is defined as mvx.

First, using the motion vector information on the motion compensation blocks A, B, and C, the predictive motion vector information pmvE for the motion compensation block E is generated as Expression (10) below according to a median operation.

[Mathematical formula 10]

pmv_{E}=med(mv_{A},mv_{B},mv_{C}) (10)

When information on the motion compensation block C is unavailable due to a reason such as being at the edge of an image frame, the information on the motion compensation block D is used instead.

Data mvdE that is encoded into the image compression information as the motion vector information for the motion compensation block E is generated as Expression (11) using pmvE.

[Mathematical formula 11]

mvd_{E}=mv_{E}−pmv_{E} (11)

Note that in actual processing the respective components of the motion vector information in the horizontal and vertical directions are processed independently.

### [Multi-Reference Frame]

Moreover, the AVC scheme defines a scheme called multi-reference frame, which is not defined in the conventional image encoding scheme such as MPEG2 or H.263.

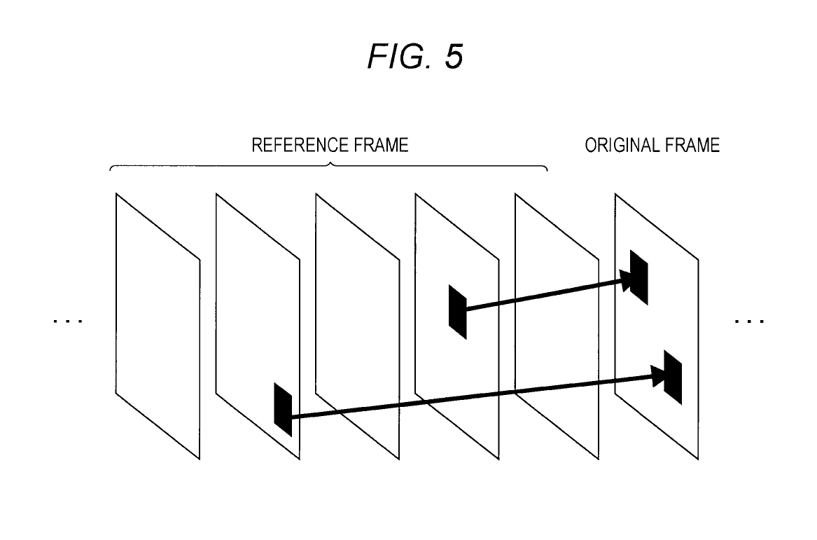

The multi-reference frame defined in the AVC scheme will be described with reference to FIG. 5.

That is, in the MPEG2 or H.263 scheme, the motion prediction/compensation process is performed in such a way that the P picture refers to only one reference frame stored in the frame memory. In contrast, as illustrated in FIG. 5, in the AVC scheme, a plurality of reference frames is stored in a memory and macroblocks can refer to different memories.

### [Direct Mode]

However, although the amount of motion vector information of B pictures is large, a mode called a direct mode is prepared in the AVC scheme.

In the direct mode, the motion vector information is not stored in the image compression information. In an image decoding device, the motion vector information of the current block is calculated from the motion vector information of a neighboring block or the motion vector information of a co-located block which is a block of a reference frame at the same position as a processing target block.

The direct mode includes two types of modes which are a spatial direct mode and a temporal direct mode, which can be switched every slice.

In the spatial direct mode, the motion vector information mvE of a processing target motion compensation block E is calculated as illustrated in Expression (12) below.

mvE=pmvE (12)

That is, the motion vector information generated by the median prediction is applied to the current block.

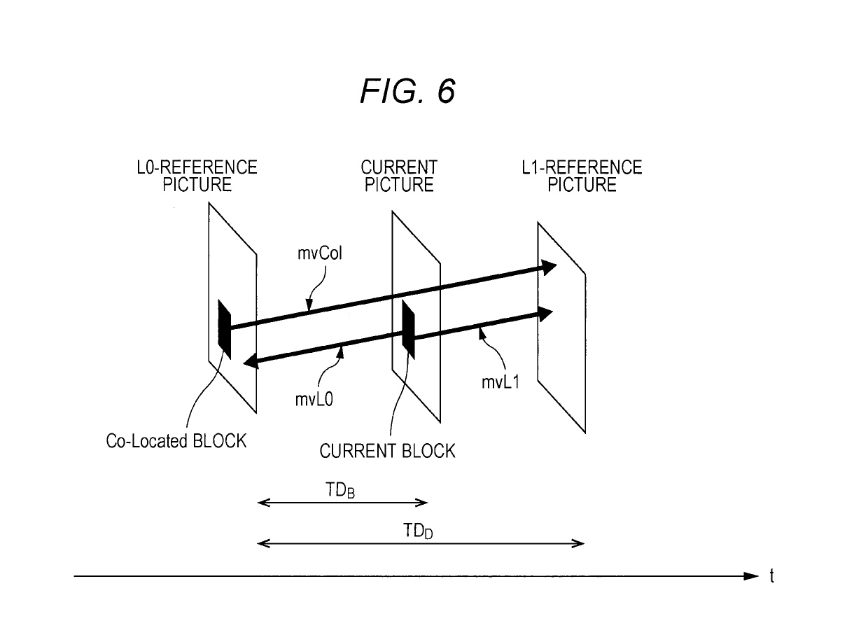

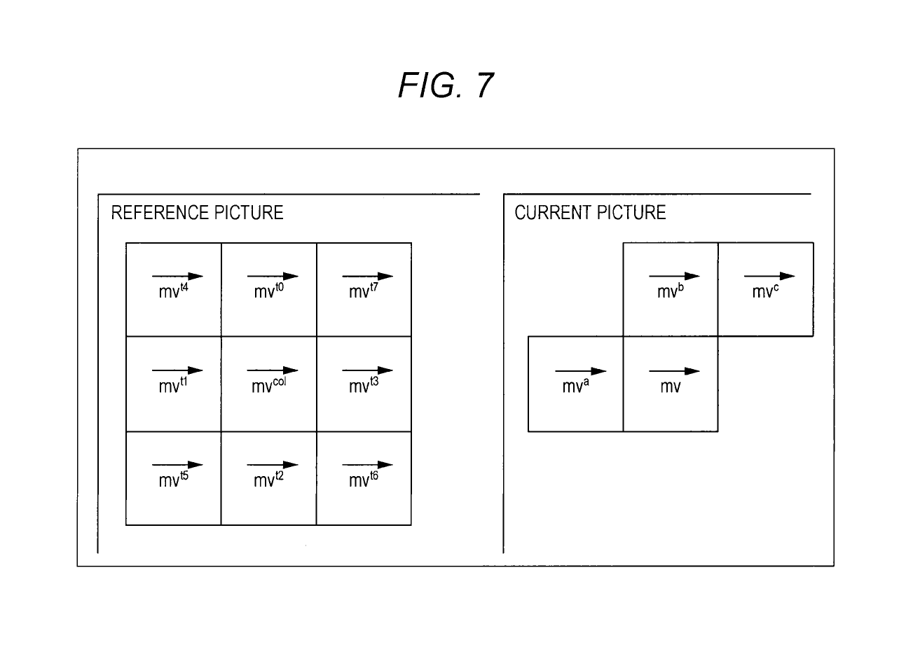

Next, the temporal direct mode will be described with reference to FIG. 6.

In FIG. 6, in the L0 reference picture, a block located at the same spatial address as the current block is a co-located block, and the motion vector information of the co-located block is defined as mvcol. Moreover, the distance on the time axis between the current picture and the L0 reference picture is TDB, and the distance on the time axis between the L0 reference picture and the L1 reference picture is defined as TDD.

In this case, the L0 motion vector information mvL0 and the L1 motion vector information mvL1 in the current picture are calculated according to Expressions (13) and (14) below.

$$\begin{matrix}[ Mathematical formula 12 ] & \\ {mv}_{L 0} = \frac{{TD}_{B}}{{TD}_{D}} {mv}_{col} & ( 13 ) \\ [ Mathematical formula 13 ] & \\ {mv}_{L 1} = \frac{{TD}_{D} - {TD}_{B}}{{TD}_{D}} {mv}_{col} & ( 14 )\end{matrix}$$

Since the information TD indicating the distance on the time axis does not exist in the AVC image compression information, the operations of Expressions (13) and (14) are performed using the picture order count (POC).

Moreover, in the AVC image compression information, the direct mode can be defined in respective macroblocks of 16×16 pixels or in respective blocks of 8×8 pixels.

### [Selection of Prediction Mode]

However, to achieve higher encoding efficiency in the AVC encoding scheme, it is important to select an appropriate prediction mode.

As an example of such a selection scheme, a method implemented in reference software (available from http://iphome.hhi.de/suchring/tml/index.htm) of the AVC scheme called joint model (JM) can be used.

In the JM scheme, two mode determination methods of high complexity mode and low complexity mode which will be described later can be selected. According to these modes, the cost function values related to the respective prediction modes are calculated, and a prediction mode in which the cost function value is minimized is selected as an optimal mode for the sub-macroblocks or the macroblocks.

The cost function of the high complexity mode is expressed by Expression (15).

Cost(ModeεΩ)=D+λ*R (15)

Here, “Ω” represents a universal set of candidate prediction modes for encoding a current block and macroblocks, and “D” represents differential energy between a decoded image and an input image when encoding is performed in the current prediction mode. “λ” represents the Lagrange multiplier given as a function of a quantization parameter. “R” represents a total code amount including orthogonal transform coefficients when encoded in the current mode.

That is, when encoding is performed in the high complexity mode, it is necessary to perform a temporary encoding process in all candidate modes in order to calculate the parameters D and R, and thus, a larger number of operations are required.

The cost function of the low complexity mode is expressed by Expression (16) below.

Cost(ModeεΩ)=D+QP2Quant(QP)*HeaderBit (16)

Here, D represents differential energy between a predicted image and an input image unlike the high complexity mode. QP2Quant(QP) is given as the function of the quantization parameter QP, and HeaderBit represents a code amount relating to information belonging to a header, such as a motion vector or a mode, which does not include the orthogonal transform coefficients.

That is, in the low complexity mode, although it is necessary to perform the prediction process for the respective candidate modes, since it does not require decoded images, it is not necessary to perform the encoding process. Thus, the cost function values can be calculated with a smaller number of operations than the high complexity mode.

### [MV Competition of Motion Vector]

However, in order to improve the motion vector encoding that uses median prediction described with reference to FIG. 4, Non-Patent Document 1 proposes the following method.

That is, the method allows any one of “temporal predictor (temporal predictive motion vector)” and “spatio-temporal predictor (spatio-temporal predictive motion vector)” to be adaptively used as predictive motion vector information in addition to “spatial predictor (spatial predictive motion vector)” obtained in the median prediction defined in the AVC scheme. This proposed method is also referred to as MV competition in the AVC scheme. This MV competition is also referred to as Advanced Motion Vector Prediction (AMVP) in the HEVC scheme.

In FIG. 7, “mvcol” is set as the motion vector information of the current block in relation to the co-located block for the current block. Moreover, mvtk (k=0 to 8) is set as the motion vector information of the neighboring block, and the respective items of predictive motion vector information (Predictor) are defined by Expressions (17) to (19), respectively. Furthermore, the co-located block for the current block is a block in which, in a reference picture referred by a current picture, the same xy coordinate as that of the current block is provided.

Temporal Predictor:

[Mathematical formula 14]

Mvₜₘ₅=median{mv_{col},mvₜ₀,mvₜ₃} (17)

[Mathematical formula 15]

Mvₜₘ₉=median{mv_{col},mvₜ₀,mvₜ₁₈} (18)

### Spatio-Temporal Predictor:

[Mathematical formula 16]

mvₛₚₜ=median{mv_{col},mv_{col},mvₐ,mv_{b},mv_{c}} (19)

In the image encoding device 100, the cost functions when the respective items of predictive motion vector information are calculated for the respective blocks, and the optimal predictive motion vector information is selected. In the image compression information, information (index) indicating which predictive motion vector information is used in the respective blocks is transmitted.

### [Coding Unit]

However, setting the size of a macroblock to 16×16 pixels is not optimal for a large image frame named UHD (Ultra High Definition; 4000×2000 pixels) that will become the subject of the next generation encoding scheme.

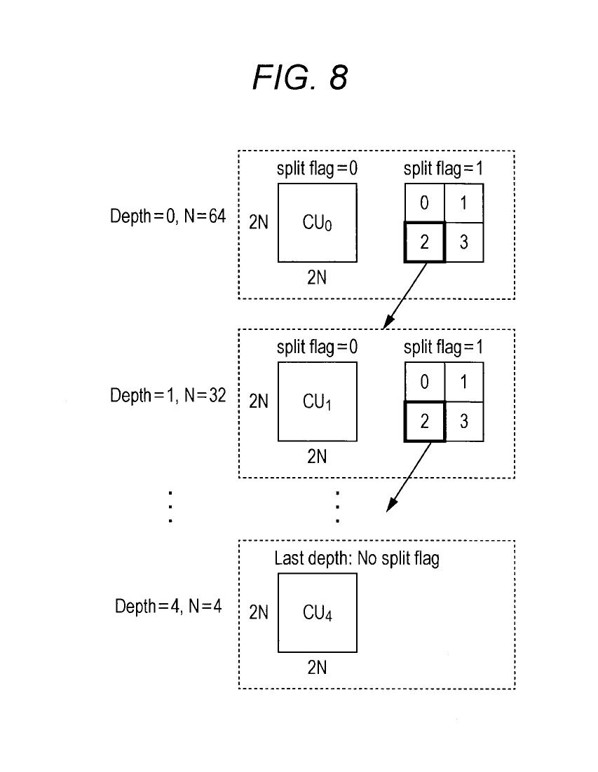

Although the AVC scheme defines layered blocks such as macroblocks or sub-macroblocks as described in FIG. 3, the HEVC scheme defines coding units (CUs) as illustrated in FIG. 8.

The CU which is also called a coding tree block (CTB) is a partial region of a picture-base image that plays the same role as the macroblock in the AVC scheme. The size of the macroblock is fixed to 16×16 pixels whereas the size of the CU is not fixed but is designated in image compression information in respective sequences.

For example, the largest size (LCU: Largest Coding Unit) and the smallest size (SCU: Smallest Coding Unit) of the CU are defined in a sequence parameter set (SPS) included in output encoded data.

Each LCU can be split into CUs of the smaller size that is not smaller than the size of SCU by setting split-flag=1. In the example of FIG. 8, the size of LCU is 128, and a largest layer depth is 5. A CU having the size of 2N×2N is split into CUs having the size of N×N which is one layer below when the value of split_flag is “1.”

Further, the CU is split into prediction units (PUs) which are regions (partial regions of a picture-base image) serving as processing units of intra or inter-prediction. Moreover, the CU is split into transform units (TUs) which are regions (partial regions of a picture-base image) serving as processing units of orthogonal transform. Presently, the HEVC scheme can use 16×16 and 32×32 orthogonal transform in addition to 4×4 and 8×8 orthogonal transform.

In the encoding schemes in which CUs are defined and various processes are performed in units of CUs as in the HEVC scheme, it can be regarded that macroblocks in the AVC scheme correspond to LCUs and blocks (sub-blocks) correspond to CUs. Moreover, it can be regarded that the motion compensation blocks in the AVC scheme correspond to PUs. However, since the CUs have a layer structure, the size of LCUs on the uppermost layer is generally set to 128×128 pixels, for example, that is larger than the size of macroblocks of the AVC scheme.

Thus, in the following description, it is assumed that the LCU includes macroblocks in the AVC scheme and the CU includes blocks (sub-blocks) in the AVC scheme.

### [Transmission Unit of Quantization Parameter]

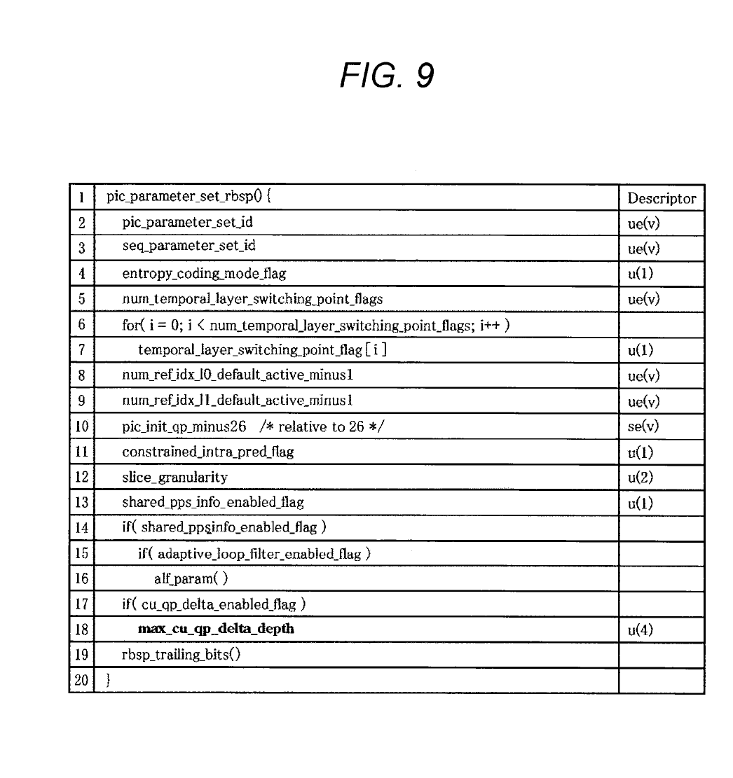

Moreover, in the HEVC scheme, it is possible to transmit quantization parameters QP in units of sub-LCUs. The size of CUs in which the quantization parameters are transmitted is described in a picture parameter set illustrated in FIG. 9 as a syntax element.

FIG. 9 is a diagram illustrating an example of a syntax element of a picture parameter set. In the example of FIG. 9, the numbers at the left ends of the respective lines are line numbers assigned for the convenience of description.

In the example of FIG. 9, “max_cu_qp_delta_depth” is set on the 18th line. The “max_cu_qp_delta_depth” is a parameter designating the size of CUs in which the quantization parameters are transmitted.

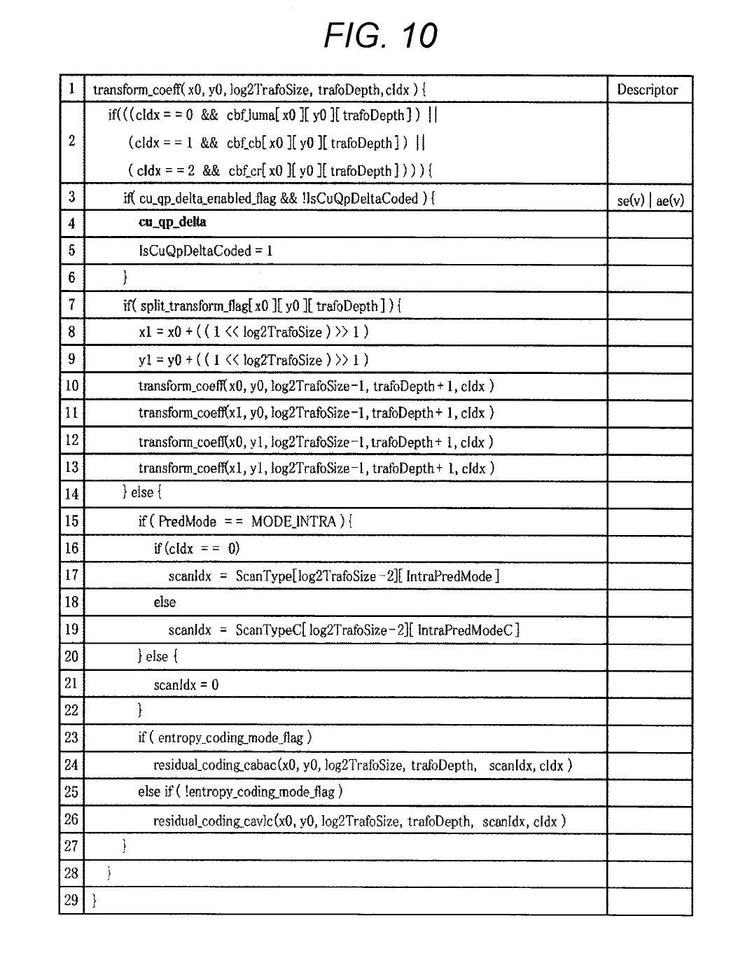

Moreover, the information on quantization parameters, included in the image compression information is described in “transform_coeff” illustrated in FIG. 10 as a syntax element.

FIG. 10 is a diagram illustrating an example of the syntax element of “transform_coeff.” In the example of FIG. 10, the numbers at the left ends of the respective lines are line numbers assigned for the convenience of description.

In the example of FIG. 10, “cu_qp_delta” is set on the fourth line. The “cu_qp_delta” is a differential quantization parameter transmitted in units of CUs. The value of “cu_qp_delta” is calculated according to a generation rule of Expression (20).

IF(left available)

QP=cu_{—}qp_delta+LeftQP

Else

QP=cu_{—}qp_delta+PrevQP (20)

“LeftQP” represents a quantization parameter of a CU located to the left of the current CU, “PrevQP” is a quantization parameter of a CU (that is, a CU located above the current CU) that is encoded or decoded immediately before the current CU.

Here, the differential quantization parameter is a difference between a quantization parameter and a predictive value (predictive quantization parameter) of the quantization parameter. That is, as illustrated in Expression (20), in the HEVC scheme, it is defined that the predictive quantization parameter of the current CU is obtained from the quantization parameter of a CU located on the left of the current CU if the CU located on the left of the current CU is available. Moreover, it is defined that the predictive quantization parameter of the current CU is obtained from the quantization parameter of a CU located above the current CU if the CU located above the current CU is not available.

### [Motion Partition Merging]

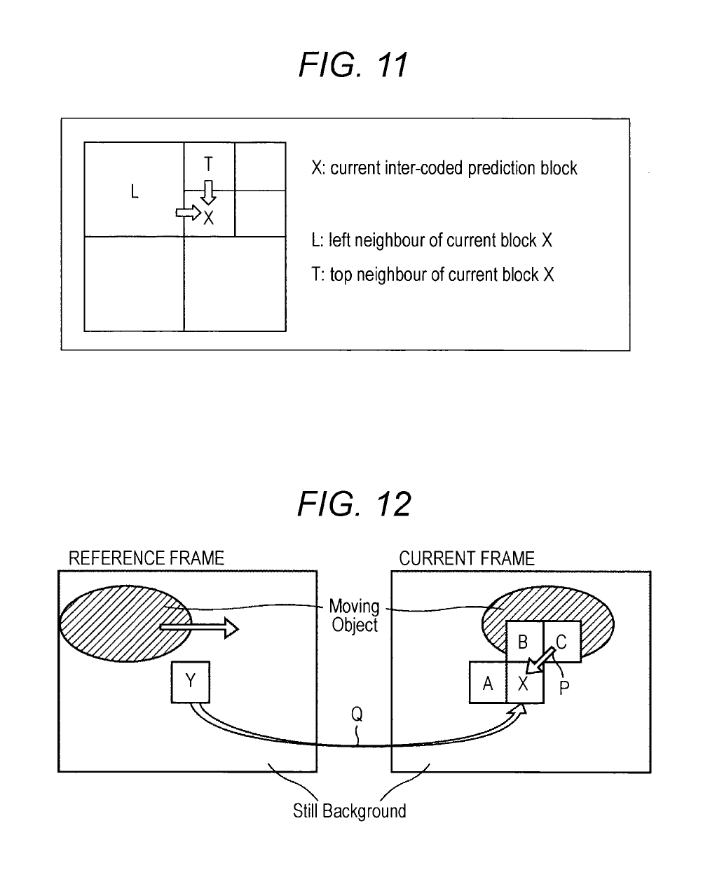

However, a method (merge mode) called motion partition merging as illustrated in FIG. 11 is proposed as one of motion information encoding schemes. In this method, two flags MergeFlag and MergeLeftFlag are transmitted as merge information which is information on a merge mode. “MergeFlag=1” indicates that the motion information of a current region X is the same as the motion information of a neighboring region T adjacent to the current region or a neighboring region L adjacent to the left of the current region. In this case, “MergeLeftFlag” is included in the merge information and is transmitted. “MergeFlag=0” indicates that the motion information of a current region X is different from the motion information of any one of the neighboring region T and the neighboring region L. In this case, the motion information of the current region X is transmitted.

When the motion information of the current region X is the same as the motion information of the neighboring region L, MergeFlag=1 and MergeLeftFlag=1. When the motion information of the current region X is the same as the motion information of the neighboring region T, MergeFlag=1 and MergeLeftFlag=0.

### [Predictive Motion Vector (Predictor) in Still Region]

In the MV competition or the merge mode, a temporal predictive motion vector (temporal predictor) realizes higher encoding efficiency in still image regions, in particular. That is, when a predictive motion vector is selected based on the cost function value illustrated in Expression (15) or (16) in such regions, a temporal predictive motion vector is more likely to be selected in the still image regions than a spatial predictive motion vector.

In the example of FIG. 12, a current frame and a reference frame that the current frame refers to are illustrated. An ellipse in the current frame and the reference frame represents a moving object, and the other region is a still background.

Moreover, in the current frame, a target region X, an adjacent region A adjacent to the left of the target region X, an adjacent region B adjacent to the above of the target region X, and an adjacent region C adjacent to the top right of the target region X are illustrated. In the reference frame, the adjacent region has the same xy coordinates as the target region X.

In the current frame, although the target region X and the adjacent region A are included in the still region, the adjacent region B and the adjacent region C are included in the moving object. Moreover, in the reference frame, the adjacent region Y is included in the still region. As illustrated in FIG. 12, when the target region X is located at the boundary of objects (a moving object and a still object), for example, the temporal predictive motion vector of the adjacent region Y is more likely to be selected than the spatial predictive motion vector of the adjacent region C.

However, in inter-slices, for example, a case in which a temporal predictive motion vector is selected in the left adjacent region and a spatial predictive motion vector is selected in the target region X, or the opposite case may occur. In this case, according to the quantization parameter prediction scheme illustrated in Expression (20), a quantization parameter encoding process is performed between the different regions of a still region and a moving region. Thus, prediction efficiency may decrease.

Therefore, in this technique, region determination is performed according to a prediction method (that is, whether the prediction method is spatial prediction or temporal prediction) of a predictive motion vector in the processing target region and the adjacent region. Moreover, the predictive quantization parameter which is a predictive value of the quantization parameter used for the encoding (decoding) of the quantization parameter is generated according to the region determination result, whereby the encoding efficiency is improved.

### [Quantization Parameter Prediction Method]

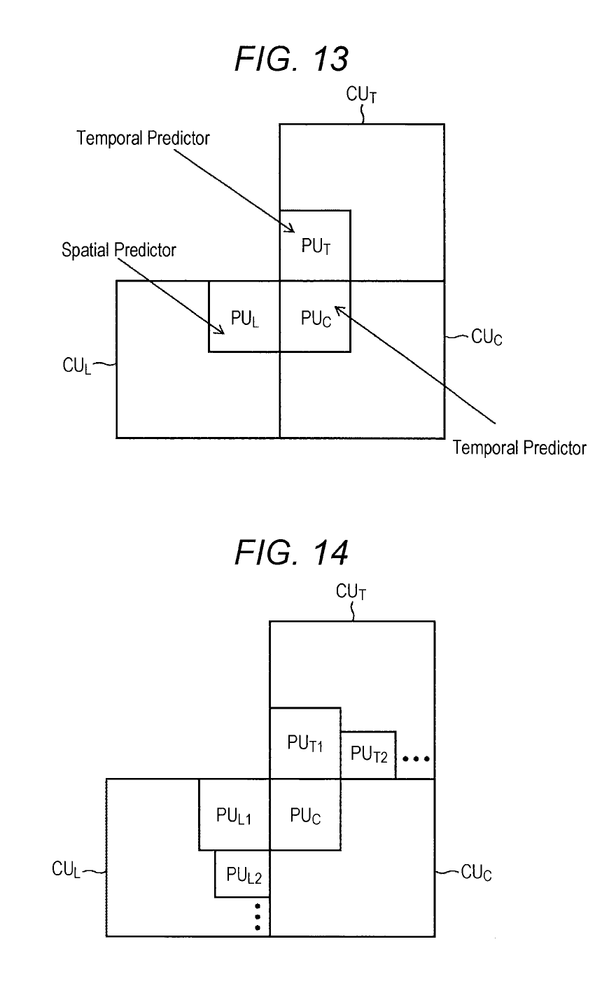

Next, a quantization parameter prediction method according to this technique will be described with reference to FIG. 13.

In the example of FIG. 13, CU_{C} which is a current coding unit, CU_{L} which is a left coding unit adjacent to the left of the CU_{C}, and CU_{T} which is a top coding unit adjacent to the top of the CU_{C} are illustrated.

CU_{C} includes PU_{C} which is a prediction unit. PUC represents a prediction unit located at the top left corner of the CUC. CU_{L} includes PU_{L} which is a prediction unit. PU_{L} is a prediction unit located at the top right corner of the CU_{L}. CU_{T} includes PU_{T} which is a prediction unit. PU_{T} is a prediction unit located at the bottom left corner of the CU_{T}. That is, PU_{C}, PU_{L}, and PU_{T} are prediction units adjacent to a pixel at the uppermost left corner of the CU_{C}. That is, PU is a sub-region of the CU.

Inter-prediction is applied to PU_{C}, PU_{L}, and PU_{T}. Moreover, in the PU_{C}, a temporal predictive motion vector (temporal predictor) is used for encoding motion vectors. In the PU_{L}, a spatial predictive motion vector (spatial predictor) is used for encoding motion vectors. In the PU_{T}, a temporal predictive motion vector (temporal predictor) is used for encoding motion vectors.

As described above, the temporal predictive motion vector is a predictive motion vector obtained by a prediction method that uses the motion vector information of PUs (that is, temporally adjacent PUs) located at the same spatial address as the current PU in different pixels on the same time axis. Moreover, as described above, the spatial predictive motion vector is a predictive motion vector obtained by a prediction method that uses the motion vector information of PUs (that is, spatially adjacent PUs) adjacent in the same picture as the current PU.

Here, as described above with reference to Expression (20), according to the method disclosed in Non-Patent Document 2, as for quantization parameters of CU_{C}, a prediction process that uses the quantization parameters of CU_{L} is performed unless CU_{L} is available.

However, different predictive motion vectors obtained by different prediction methods are applied to PU_{C} and PU_{L}. Thus, PU_{C} and PU_{L} are considered to belong to different regions, and performing the process of predicting the quantization parameters of CU_{C} using the quantization parameters of CU_{L} may result in a decrease in the encoding efficiency.

Therefore, in this technique, by applying the same predictive motion vectors to PU_{C} and PU_{T} so that CU_{C} and CU_{T} are considered to be the same region, it is assumed that the quantization parameter of CU_{C} is predicted using the quantization parameter of CU_{T}.

Specifically, the image encoding device 100 refers to the predictive motion vector of the current PU_{C} and the predictive motion vectors of respective adjacent PUs adjacent to the current PU_{C} and determines the CU_{T}, to which an adjacent PU_{T} having the predictive motion vector of the same prediction method as the current PU_{C} belongs, as a region referred to when generating the predictive quantization parameter of the current CU_{C}.

That is, the predictive quantization parameter of the current CU_{C} is generated according to the prediction method of the predictive motion vector of the adjacent CU adjacent to the current CU_{C}. More specifically, the predictive quantization parameter of the current CU_{C} is generated depending on whether the prediction method of the predictive motion vector of the adjacent CU adjacent to the current CU_{C} is spatial prediction or temporal prediction.

In this manner, since the quantization parameter of the adjacent CU that is considered to belong to the same region as the current CU_{C} is used for generating the predictive quantization parameter, it is possible to improve the efficiency of predictive encoding of quantization parameters.

In the example of FIG. 13, an example in which the predictive motion vector information (predictor) in PU_{C}, PU_{L}, and PU_{T} which are prediction units adjacent to the pixel located at the uppermost left corner of the CU_{C} is referred to has been illustrated. However, the predictive motion vector information referred to is not limited to the information of the prediction unit adjacent to the pixel located at the uppermost left corner of the CU_{C}.

For example, as illustrated in FIG. 14, the predictive motion vector information (predictor) of all prediction units adjacent to the top or bottom of the current CU_{C} can be used for reference.

In the example of FIG. 14, similarly to the case of the example of FIG. 13, CU_{C} includes PU_{C} which is a prediction unit. PUC represents a prediction unit located at the top left corner of the CUC.

In contrast, CU_{L} includes PU_{L1}, PU_{L2}, . . . , and the like which are prediction units. PU_{L1} is a prediction unit located at the top right corner of the CU_{L}, PU_{L2} is located below PU_{L1}, and another PU_{L} (not illustrated) is located below PU_{L2}. That is, PU_{L1}, PU_{L2}, . . . , and the like are PUs that are adjacent to the left of CU_{C}.

Moreover, CU_{T} includes PU_{T1}, PU_{T2}, . . . , and the like which are prediction units. PU_{T1} is a prediction unit located at the top right corner of the CU_{L}, PU_{T2} is located below PU_{T1}, and another PU_{T} (not illustrated) is located below PU_{T2}. That is, PU_{T1}, PU_{T2}, . . . , and the like are PUs that are adjacent to the top of CU_{C}.

In the example of FIG. 14, when the predictive motion vector information of any one of the PUs of PU_{L1}, PU_{L2}, . . . , and the like that are adjacent to the left of CU_{C} have the same predictive motion vector information (belong to the same region) as PU_{C}, the quantization parameter of CU_{L} is used for generating the predictive quantization parameter of CU_{C}.

On the other hand, when the predictive motion vector information of any one of the PUs of PU_{T1}, PU_{T2}, . . . , and the like that are adjacent to the top of CU_{C} have the same predictive motion vector information (belong to the same region) as PU_{C}, the quantization parameter of CU_{T} is used for generating the predictive quantization parameter of CU_{C}.

In this manner, in the case of the example of FIG. 14, since the quantization parameter of a PU (CU) that is considered to belong to the same region is used for prediction of the quantization parameter of the current CU, it is possible to improve the efficiency of predictive encoding of quantization parameters.

In the HEVC scheme, the motion vector of a region located to the left of the current PU and the motion vector of a region located to the top of the current PU can be used as the spatial predictive motion vector. Thus, in this technique, the quantization parameter prediction process may be controlled depending on whether a spatial predictor or a temporal predictor is used, and in the case of spatial predictor, whether the left region or the top region is used. That is, when the same spatial predictive motion vector as the current region is predicted in adjacent regions that are adjacent to the top and left of the current region, and the current region refers to the information of the top region, the quantization parameter of the adjacent region that refers to the top region is used similarly to the current region.

Moreover, in this technique, when a bi-predictive prediction is applied to respective CUs as adjacent regions, a region determining process is performed using the predictive motion vector information on one list, for example.

For example, the region determining process is performed using information on List0 only. Alternatively, the region determining process is performed using List0 for pictures which are not reordered and List1 for pictures which are reordered.

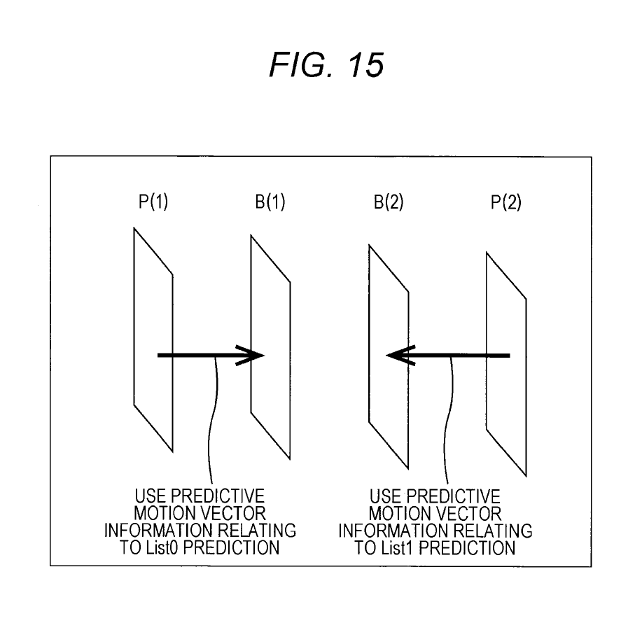

Further, in the example of FIG. 15, a P(1) picture, a first B(1) picture, a second B(2) picture, and a P(2) picture for m=3 are illustrated in a time-sequential order. In this case, during processing of the first B(1) picture, information on the predictive motion vector (predictor) of the temporally close P(1) picture relating to List0 prediction is used. On the other hand, during processing of the second B(2) picture, information on the predictive motion vector (predictor) of the temporally close P(2) picture relating to List1 prediction is used.

In this manner, whether List0 prediction or List1 prediction is used may be determined by taking the distance on the time axis to a reference picture into consideration.

Moreover, the region determination may be performed by taking a prediction direction also into consideration. That is, when the PUs included in the current CU and the top adjacent CU are subjected to bi-predictive prediction whereas the PUs included in the left adjacent CU are subjected to single-predictive prediction, the quantization parameter of the current CU is predicted using the quantization parameter of the top adjacent CU.

Here, in general, in an encoding device and a decoding device of the HEVC scheme, the parameters such as the motion vector information and the predictive motion vector information of the adjacent regions are stored in a line buffer and are used for encoding of the current region. Thus, the method of this technique can perform processing using the adjacent predictive motion vector information without increasing the size of the line buffer.

### [Configuration Example of Motion Vector Encoding Unit, Region Determining Unit, and Quantization Unit]

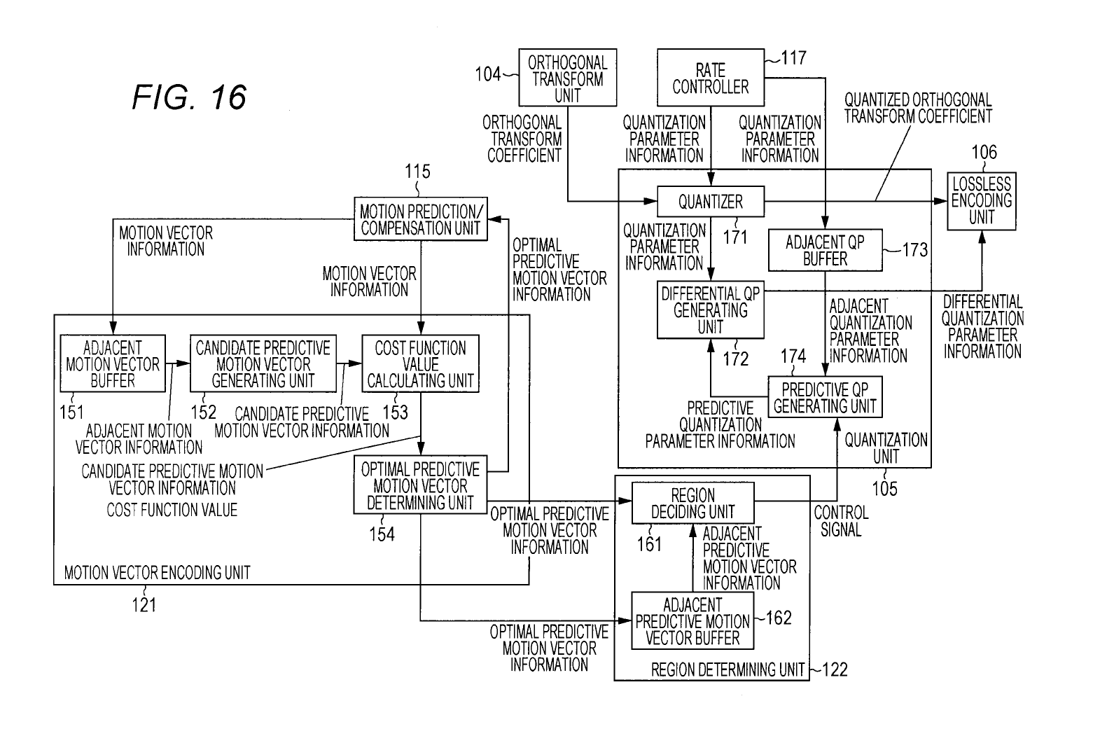

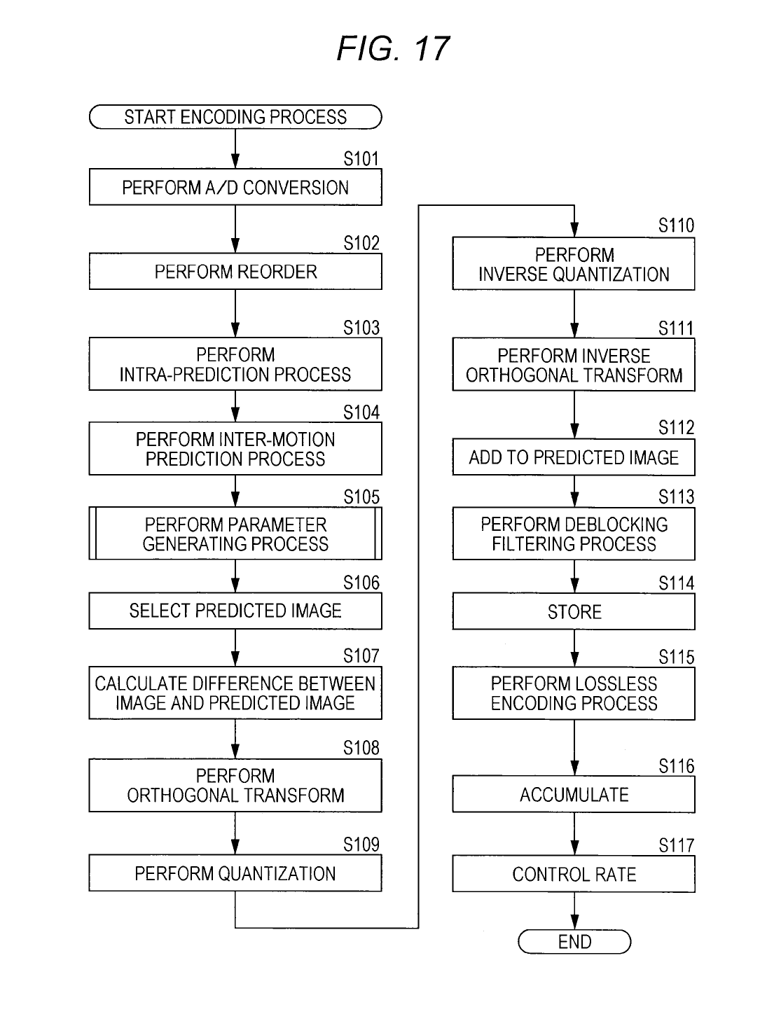

FIG. 16 is a block diagram illustrating an example of main components of the motion vector encoding unit 121, the region determining unit 122, and the quantization unit 105.

In the example of FIG. 16, the motion vector encoding unit 121 is configured to include an adjacent motion vector buffer 151, a candidate predictive motion vector generating unit 152, a cost function value calculating unit 153, and an optimal predictive motion vector determining unit 154.

The region determining unit 122 is configured to include a region deciding unit 161 and an adjacent predictive motion vector buffer 162.

The quantization unit 105 is configured to include a quantizer 171, a differential QP generating unit 172, an adjacent QP buffer 173, and a predictive QP generating unit 174.

The information of the motion vector searched by the motion prediction/compensation unit 115 is supplied to the adjacent motion vector buffer 151 and the cost function value calculating unit 153. The adjacent motion vector buffer 151 accumulates the motion vector information supplied from the motion prediction/compensation unit 115 as the information of the motion vectors of the adjacent regions. The information of the motion vector of the adjacent region, accumulated in the adjacent motion vector buffer 151 includes information of the motion vectors of spatially adjacent regions and information of the motion vectors of temporally adjacent regions (regions located at the same spatial address as the current region in different pictures on the time axis).

The candidate predictive motion vector generating unit 152 reads information indicating the motion vectors obtained for the adjacent PUs that are temporally or spatially adjacent to the current PU from the adjacent motion vector buffer 151. The candidate predictive motion vector generating unit 152 generates candidate predictive motion vectors of the current PU by referring to the read motion vector information and supplies information indicating the generated candidate predictive motion vectors to the cost function value calculating unit 153.

The cost function value calculating unit 153 calculates the cost function values of the respective candidate predictive motion vectors and supplies the calculated cost function values to the optimal predictive motion vector determining unit 154 together with the information of the candidate predictive motion vectors.

The optimal predictive motion vector determining unit 154 determines the candidate predictive motion vector that minimizes the cost function value from the cost function value calculating unit 153 serving as an optimal predictive motion vector for the current PU and supplies information on the determination result to the motion prediction/compensation unit 115.

The motion prediction/compensation unit 115 generates a differential motion vector which is a difference from the motion vector using the information of the optimal predictive motion vector supplied from the optimal predictive motion vector determining unit 154 and calculates the cost function values of the respective prediction modes. The motion prediction/compensation unit 115 determines a prediction mode that minimizes the cost function value as an optimal inter-prediction mode among the prediction modes.

The motion prediction/compensation unit 115 supplies a predicted image of the optimal inter-prediction mode to the predicted image selector 116. Moreover, the motion prediction/compensation unit 115 supplies the generated differential motion vector information to the lossless encoding unit 106 for encoding of motion vectors.

In the example of FIG. 16, although not illustrated in the drawing, the information indicating the optimal inter-prediction mode is supplied from the motion prediction/compensation unit 115 to the optimal predictive motion vector determining unit 154.

The optimal predictive motion vector determining unit 154 supplies information of the optimal predictive motion vector of the optimal inter-prediction mode, indicated by the information supplied from the motion prediction/compensation unit 115 to the region deciding unit 161 and the adjacent predictive motion vector buffer 162.

When the information of the optimal predictive motion vector of the current PU is supplied, the region deciding unit 161 reads the information of the optimal predictive motion vector of an adjacent CU adjacent to the current PU from the adjacent predictive motion vector buffer 162. The region deciding unit 161 decides a PU (region) referred to for generating the predictive quantization parameter among the adjacent PUs according to the method described with reference to FIGS. 13 to 15 by referring to the optimal predictive motion vector of the current PU and the optimal predictive motion vectors of the adjacent PUs. The region deciding unit 161 supplies a control signal to the predictive QP generating unit 174 so that the decided PU is referred to.

The adjacent predictive motion vector buffer 162 accumulates the optimal predictive motion vector information supplied from the optimal predictive motion vector determining unit 154 as adjacent predictive motion vector information of the adjacent PU (the PU located to the top or left) used for deciding the region of the current PU.

On the other hand, the quantization parameter information (that is, quantization parameter value) of the current CU supplied from the rate controller 117 is supplied to the quantizer 171 and the adjacent QP buffer. Moreover, the orthogonal transform coefficient of the current CU supplied from the orthogonal transform unit 104 is supplied to the quantizer 171.

The quantizer 171 quantizes the orthogonal transform coefficient using the quantization parameter value indicated by the information supplied from the rate controller 117 and supplies the quantized orthogonal transform coefficient of the current CU to the lossless encoding unit 106. Moreover, the quantizer 171 supplies the quantization parameter information of the current CU to the differential QP generating unit 172.

The differential QP generating unit 172 receives the predictive quantization parameter information of the current CU from the predictive QP generating unit 174. The differential QP generating unit 172 obtains a differential quantization parameter which is a difference between the quantization parameter of the current CU and the predictive quantization parameter of the current CU and supplies the differential quantization parameter information to the lossless encoding unit 106.

The adjacent QP buffer 173 accumulates the quantization parameter information supplied from the rate controller 117 as the quantization parameter information of the adjacent CU adjacent to the current CU, which is used for generating the predictive quantization parameter of the current CU.

The predictive QP generating unit 174 reads the adjacent quantization parameter of the region (an adjacent CU to which the adjacent PU belongs) indicated by the control signal supplied from the region deciding unit 161 from the adjacent QP buffer 173. The predictive QP generating unit 174 uses the read adjacent quantization parameter as the predictive quantization parameter of the current CU and supplies the predictive quantization parameter information of the current CU to the differential QP generating unit 172.

### [Flow of Encoding Process]

Next, the flow of the respective processes executed by the image encoding device 100 having such a configuration will be described. First, an example of the flow of the encoding process will be described with reference to the flowchart of FIG. 17.

In step S101, the A/D converter 101 performs A/D conversion on an input image. In step S102, the screen reorder buffer 102 stores the A/D-converted image and reorders the respective pictures so that the pictures arranged in the display order is reordered in the encoding order.

In step S103, the intra-prediction unit 114 performs an intra-prediction process in the intra-prediction mode. In step S104, the motion prediction/compensation unit 115 performs an inter-motion prediction process of performing motion prediction and motion compensation in the inter-prediction mode. The information of the motion vector searched by the motion prediction/compensation unit 115 is supplied to the adjacent motion vector buffer 151 and the cost function value calculating unit 153.

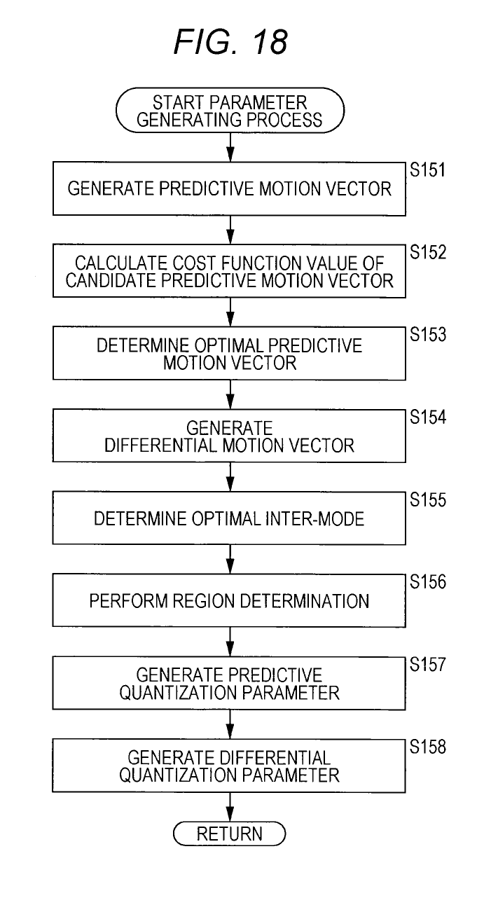

In step S105, the motion vector encoding unit 121, the region determining unit 122, and the quantization unit 105 performs a parameter generating process which is a process of generating a predictive motion vector, a predictive (differential) quantization parameter, and the like. Details of the parameter generating process will be described with reference to FIG. 18.

With the process of step S105, the predictive motion vectors of the current PU are generated, and an optimal predictive motion vector of the current PU is determined among the predictive motion vectors. A region referred to for generating the predictive quantization parameter is determined among the adjacent PUs adjacent to the current PU according to the prediction method of the predictive motion vectors of the adjacent PUs. The quantization parameter of the determined region is used as the predictive quantization parameter, and the differential quantization parameter is generated.

The generated differential quantization parameter information is supplied to the lossless encoding unit 106, and is subjected to lossless encoding in step S115 described later. Moreover, the predicted image and the cost function value of the optimal inter-prediction mode are supplied from the motion prediction/compensation unit 115 to the predicted image selector 116.

In step S106, the predicted image selector 116 selects an optimal mode based on the cost function values output from the intra-prediction unit 114 and the motion prediction/compensation unit 115. That is, the predicted image selector 116 selects any one of the predicted image generated by the intra-prediction unit 114 and the predicted image generated by the motion prediction/compensation unit 115.

In step S107, the arithmetic unit 103 calculates a difference between the image reordered by the process of step S102 and the predicted image selected by the process of step S106. The difference data has a smaller data amount than the original data. Thus, it is possible to compress the data amount as compared to when the image is encoded as it is.

In step S108, the orthogonal transform unit 104 performs orthogonal transform on the difference information generated by the process of step S107. Specifically, orthogonal transform such as discrete cosine transform or Karhunen-Loeve transform is performed, and transform coefficients are output.

In step S109, the quantizer 171 of the quantization unit 105 quantizes the orthogonal transform coefficients obtained by the process of step S108 using the quantization parameter supplied from the rate controller 117.

The difference information quantized by the process of step S109 is locally decoded in the following manner. That is, in step S110, the inverse quantization unit 108 performs inverse quantization on the quantized orthogonal transform coefficients (also referred to as quantization coefficients) generated by the process of step S109 according to a property corresponding to the property of the quantization unit 105. In step S111, the inverse orthogonal transform unit 109 performs inverse orthogonal transform on the orthogonal transform coefficients obtained by the process of step S108 according to a property corresponding to the property of the orthogonal transform unit 104.

In step S112, the arithmetic unit 110 adds the predicted image to the locally decoded difference information to generate a locally decoded image (an image corresponding to the input of the arithmetic unit 103). In step S113, the deblocking filter 111 performs a deblocking filtering process appropriately with respect to the locally decoded image obtained by the process of step S112.

In step S114, the frame memory 112 stores the decoded image having been subjected to the deblocking filtering process by the process of step S113. The arithmetic unit 110 also supplies images that have not been subjected to the filtering process of the deblocking filter 111 to the frame memory 112 which stores the images.

In step S115, the lossless encoding unit 106 encodes the transform coefficients quantized by the process of step S109. That is, lossless encoding such as variable-length encoding or arithmetic encoding is performed with respect to the difference image.

The lossless encoding unit 106 encodes the differential quantization parameter calculated in step S105 and adds encoded data to the differential quantization parameter. Moreover, the lossless encoding unit 106 encodes information on the prediction mode of the predicted image selected by the process of step S106 and adds the information to the encoded data obtained by encoding the difference image. That is, the lossless encoding unit 106 encodes the optimal intra-prediction mode information supplied from the intra-prediction unit 114 or the information on the optimal inter-prediction mode supplied from the motion prediction/compensation unit 115 and adds the information to the encoded data. When the predicted image of the inter-prediction mode is selected by the process of step S106, the information on the differential motion vector calculated in step S105 and the flag indicating the index of the predictive motion vector are also encoded.

In step S116, the accumulation buffer 107 accumulates the encoded data obtained by the process of step S115. The encoded data accumulated in the accumulation buffer 107 is appropriately read and is transmitted to the decoding side via a transmission line or a recording medium.

In step S117, the rate controller 117 controls the rate of the quantization operation of the quantization unit 105 based on the code amount (generated code amount) of the encoded data accumulated in the accumulation buffer 107 by the process of step S116 so that an overflow or an underflow does not occur. Moreover, the rate controller 117 supplies information on the quantization parameter to the quantization unit 105.

When the process of step S117 ends, the encoding process ends.

### [Flow of Parameter Generating Process]

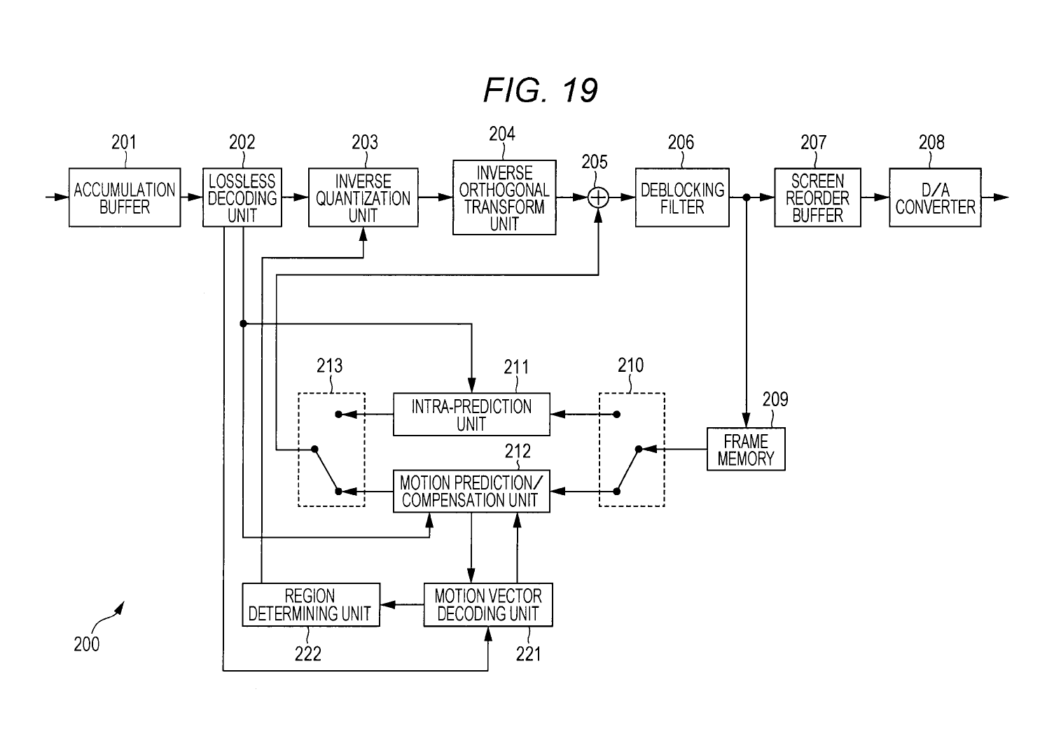

Next, an example of the flow of the parameter generating process executed in step S104 of FIG. 19 will be described with reference to the flowchart of FIG. 18. This parameter generating process is a process of generating predictive motion vectors, predictive (differential) quantization parameters, and the like used for encoding and decoding of motion vectors and quantization parameters. Steps S154 and S155 of FIG. 19 are the processes of the motion prediction/compensation unit 115.

The motion vector information searched by the motion prediction/compensation unit 115 is supplied to the adjacent motion vector buffer 151 and the cost function value calculating unit 153. In step S151, the candidate predictive motion vector generating unit 152 generates candidate predictive motion vectors of the current PU by referring to the motion vector information read from the adjacent motion vector buffer 151. The candidate predictive motion vector generating unit 152 supplies the generated candidate predictive motion vector information to the cost function value calculating unit 153.

In step S152, the cost function value calculating unit 153 calculates the cost function values of the respective candidate predictive motion vectors generated by the candidate predictive motion vector generating unit 152. The cost function value calculating unit 153 supplies the calculated cost function values to the optimal predictive motion vector determining unit 154 together with the candidate predictive motion vector information.

In step S153, the optimal predictive motion vector determining unit 154 determines the candidate predictive motion vector that minimizes the cost function value from the cost function value calculating unit 153 serving as an optimal predictive motion vector for the current PU and supplies information on the determination result to the motion prediction/compensation unit 115.

In step S154, the motion prediction/compensation unit 115 generates a differential motion vector which is a difference from the motion vector using the information of the optimal predictive motion vector supplied from the optimal predictive motion vector determining unit 154 and calculates the cost function values of the respective prediction modes.

In step S154, the motion prediction/compensation unit 115 determines a prediction mode that minimizes the cost function value as an optimal inter-prediction mode among the prediction modes. The motion prediction/compensation unit 115 supplies a predicted image of the optimal inter-prediction mode to the predicted image selector 116. Moreover, the optimal inter-prediction mode information, the differential motion vector information of the optimal inter-prediction mode, the flag indicating the index of the predictive motion vector, and the like are supplied to the lossless encoding unit 106 and are encoded in step S115 of FIG. 17.

The motion prediction/compensation unit 115 supplies the information indicating the optimal inter-prediction mode to the optimal predictive motion vector determining unit 154. In line with this, the optimal predictive motion vector determining unit 154 supplies information of the optimal predictive motion vector of the optimal inter-prediction mode, indicated by the information supplied from the motion prediction/compensation unit 115 to the region deciding unit 161 and the adjacent predictive motion vector buffer 162.

When the information of the optimal predictive motion vector of the current PU is supplied, the region deciding unit 161 reads the information of the optimal predictive motion vector of an adjacent CU adjacent to the current PU from the adjacent predictive motion vector buffer 162. In step S156, the region deciding unit 161 performs region determination as described with reference to FIGS. 13 to 15, by referring to the optimal predictive motion vector information of the current PU and the read optimal predictive motion vector information of the adjacent PU. That is, in step S156, the region deciding unit 161 decides a region (a CU in which the PU is included) referred to for generating the predictive quantization parameter among the adjacent PUs by referring to the optimal predictive motion vector of the current PU and the optimal predictive motion vectors of the adjacent PUs.

The region deciding unit 161 supplies a control signal to the predictive QP generating unit 174 so that the decided PU is referred to. The predictive QP generating unit 174 reads the adjacent quantization parameter of the region (an adjacent CU to which the adjacent PU belongs) indicated by the control signal supplied from the region deciding unit 161 from the adjacent QP buffer 173.

In step S157, the predictive QP generating unit 174 uses the read adjacent quantization parameter as the predictive quantization parameter of the current CU and supplies the predictive quantization parameter information of the current CU to the differential QP generating unit 172. The quantization parameter information supplied from the rate controller 117 is supplied to the differential QP generating unit 172 via the quantizer 171.

In step S158, the differential QP generating unit 172 obtains a differential quantization parameter which is a difference between the quantization parameter of the current CU and the predictive quantization parameter of the current CU and supplies the differential quantization parameter information to the lossless encoding unit 106.

As above, since adjacent regions having the same predictive motion vector as the current region (processing target region) are referred to for generating the predictive quantization parameter of the current region, it is possible to improve the encoding efficiency of the differential quantization parameter.

That is, the differential quantization parameter is generated by referring to the predictive motion vector generated in the MV competition or merge mode, and the encoding efficiency can be improved.

Moreover, the information used for the region determination is information necessary for reconstructing motion vectors on the decoding side and is predictive motion vector information which is transmitted to the decoding side in the conventional technique. Thus, it is not necessary to transmit additional information and an increase in the number of encoding bits is suppressed.

### 2. Second Embodiment

### Image Decoding Device

Next, decoding of the encoded data encoded in the above-described manner will be described. FIG. 19 is a block diagram illustrating an example of main components of an image decoding device corresponding to the image encoding device 100 of FIG. 1.

An image decoding device 200 illustrated in FIG. 19 decodes the encoded data generated by the image encoding device 100 according to a decoding method corresponding to the encoding method. It is assumed that the image decoding device 200 performs inter-prediction in units of prediction units (PUs) similarly to the image encoding device 100.

As illustrated in FIG. 19, the image decoding device 200 includes an accumulation buffer 201, a lossless decoding unit 202, an inverse quantization unit 203, an inverse orthogonal transform unit 204, an arithmetic unit 205, a deblocking filter 206, a screen reorder buffer 207, and a D/A converter 208. Moreover, the image decoding device 200 includes a frame memory 209, a selector 210, an intra-prediction unit 211, a motion prediction/compensation unit 212, and a selector 213.

Further, the image decoding device 200 includes a motion vector decoding unit 221 and a region determining unit 222.

The accumulation buffer 201 accumulates the encoded data transmitted thereto and supplies the encoded data to the lossless decoding unit 202 at a predetermined timing. The lossless decoding unit 202 decodes the information encoded by the lossless encoding unit 106 of FIG. 1, supplied from the accumulation buffer 201 according to a scheme corresponding to the encoding scheme of the lossless encoding unit 106. The lossless decoding unit 202 supplies quantized coefficient data of the difference image obtained by decoding to the inverse quantization unit 203.

Moreover, the lossless decoding unit 202 determines whether the intra-prediction mode or the inter-prediction mode is selected as the optimal prediction mode and supplies the information on the optimal prediction mode to the intra-prediction unit 211 or the motion prediction/compensation unit 212 based on the determination result. That is, for example, when the image encoding device 100 selected the inter-prediction mode as the optimal prediction mode, the information on the optimal prediction mode is supplied to the motion prediction/compensation unit 212.

The inverse quantization unit 203 acquires information of the differential quantization parameter of the target region (current CU) from the lossless decoding unit 202. The inverse quantization unit 203 generates a predictive quantization parameter of the target region under the control of the region determining unit 222 using the quantization parameter of the adjacent regions spatially adjacent to the target region. The inverse quantization unit 203 reconstructs the quantization parameter by adding the differential quantization parameter of the target region and the predictive quantization parameter of the target region.

The inverse quantization unit 203 performs inverse quantization on the quantized coefficient data that the lossless decoding unit 202 obtained by decoding according to a scheme corresponding to the quantization scheme of the quantization unit 105 of FIG. 1 using the reconstructed quantization parameter and supplies the obtained coefficient data to the inverse orthogonal transform unit 204.

The inverse orthogonal transform unit 204 performs inverse orthogonal transform on the coefficient data supplied from the inverse quantization unit 203 according to a scheme corresponding to the orthogonal transform scheme of the orthogonal transform unit 104 of FIG. 1. The inverse orthogonal transform unit 204 obtains the decoded residual data corresponding to the residual data before being subjected to the orthogonal transform of the image encoding device 100 by the inverse orthogonal transform process.

The decoded residual data obtained through inverse orthogonal transform is supplied to the arithmetic unit 205. Moreover, the predicted image from the intra-prediction unit 211 or the motion prediction/compensation unit 212 is supplied to the arithmetic unit 205 via the selector 213.

The arithmetic unit 205 adds the decoded residual data and the predicted image to obtain decoded image data corresponding to the image before the predicted image is subtracted by the arithmetic unit 103 of the image encoding device 100. The arithmetic unit 205 supplies the decoded image data to the deblocking filter 206.

The deblocking filter 206 performs a deblocking filtering process with respect to the supplied decoded image and supplies the decoded image to the screen reorder buffer 207. The deblocking filter 206, the loop filter 206 removes a block distortion of the decoded image by performing a deblocking filtering process on the decoded image.

The deblocking filter 206 supplies the filtering process result (filtered decoded image) to the screen reorder buffer 207 and the frame memory 209. The decoded image output from the arithmetic unit 205 may be supplied to the screen reorder buffer 207 and the frame memory 209 without via the deblocking filter 206. That is, the filtering process of the deblocking filter 206 may not be performed.

The screen reorder buffer 207 performs screen reorder. That is, the frames reordered in the encoding order by the screen reorder buffer 102 of FIG. 1 are reordered so that the frames are reordered in the original display order. The D/A converter 208 performs D/A conversion on the decoded image supplied from the screen reorder buffer 207 and outputs the converted image to a display (not illustrated) which displays the image.

The frame memory 209 stores the supplied decoded image and supplies the stored decoded image to the selector 210 as a reference image at a predetermined timing or based on an external request from the intra-prediction unit 211, the motion prediction/compensation unit 212, or the like.

The selector 210 selects a destination of the reference image supplied from the frame memory 209. When an image having been subjected to intra-encoding is decoded, the selector 210 supplies the reference image supplied from the frame memory 209 to the intra-prediction unit 211. Moreover, when an image having been subjected to inter-encoding is decoded, the selector 210 supplies the reference image supplied from the frame memory 209 to the motion prediction/compensation unit 212.

The lossless decoding unit 202 appropriately supplies information indicating an intra-prediction mode obtained by decoding header information to the intra-prediction unit 211. The intra-prediction unit 211 performs intra-prediction using the reference image acquired from the frame memory 209 in the intra-prediction mode used in the intra-prediction unit 114 of FIG. 1 to generate a predicted image. The intra-prediction unit 211 supplies the generated predicted image to the selector 213.

The motion prediction/compensation unit 212 acquires the information (optimal prediction mode information, reference image information, and the like) obtained by decoding the header information from the lossless decoding unit 202.

The motion prediction/compensation unit 212 performs inter-prediction using the reference image acquired from the frame memory 209 in the inter-prediction mode that is indicated by the optimal prediction mode information acquired from the lossless decoding unit 202 to generate a predicted image. In this case, the motion prediction/compensation unit 212 performs the inter-prediction by referring to the motion vector information reconstructed by the motion vector decoding unit 221.

The selector 213 supplies the predicted image from the intra-prediction unit 211 or the predicted image from the motion prediction/compensation unit 212 to the arithmetic unit 205.

The motion vector decoding unit 221 acquires information on the predictive motion vector index and the information on the differential motion vector among the items of information obtained by decoding the header information from the lossless decoding unit 202. Here, the predictive motion vector index is information indicating an adjacent region used for predicting (generating the predictive motion vector) the motion vector of each PU among adjacent regions adjacent temporally and spatially to the PU. The information on the differential motion vector is information indicating the value of the differential motion vector.

The motion vector decoding unit 221 reconstructs the predictive motion vector using the motion vector of the PU, indicated by the index of the predictive motion vector and adds the reconstructed predictive motion vector and the differential motion vector supplied from the lossless decoding unit 202 to reconstruct the motion vector. The motion vector decoding unit 221 supplies the information on the reconstructed motion vector to the motion prediction/compensation unit 212. Moreover, the motion vector decoding unit 221 supplies the information of the index of the predictive motion vector supplied from the lossless decoding unit 202 to the region determining unit 222.

The region determining unit 222 determines an adjacent region of which the quantization parameter is to be used as the predictive quantization parameter of the target region based on the index of the predictive motion vector supplied from the motion vector decoding unit 221. The region determining unit 122 controls the predictive quantization parameter generating process of the inverse quantization unit 203 based on the determination result.

That is, in the image decoding device 200 of FIG. 19, the inverse quantization unit 202 generates the predictive quantization parameter of the target region under the control of the region determining unit 222 according to the method of predicting the predictive motion vector of the adjacent region.

The principle of the basic operation according to this technique, of the motion vector decoding unit 221 and the region determining unit 222 is the same as that of the motion vector encoding unit 121 and the region determining unit 122 of FIG. 1. However, in the image encoding device 100 illustrated in FIG. 1, an optimal parameter is selected from candidate predictive motion vectors, and the quantization parameter is encoded (that is, the predictive quantization parameter is generated) according to the information on the selected optimal predictive motion vector.

On the other hand, in the image decoding device 200 illustrated in FIG. 19, information (the information indicating the index of the predictive motion vector) on a prediction method used for generating the predictive motion vector of each PU, used for encoding the motion vector (generating the differential motion vector) is transmitted from the encoding side. Thus, the region determination is performed according to the information indicating the index of the predictive motion vector and the quantization parameter is encoded (that is, the predictive quantization parameter is generated).

### [Configuration Example of Motion Vector Decoding Unit, Region Determining Unit, and Inverse Quantization Unit]

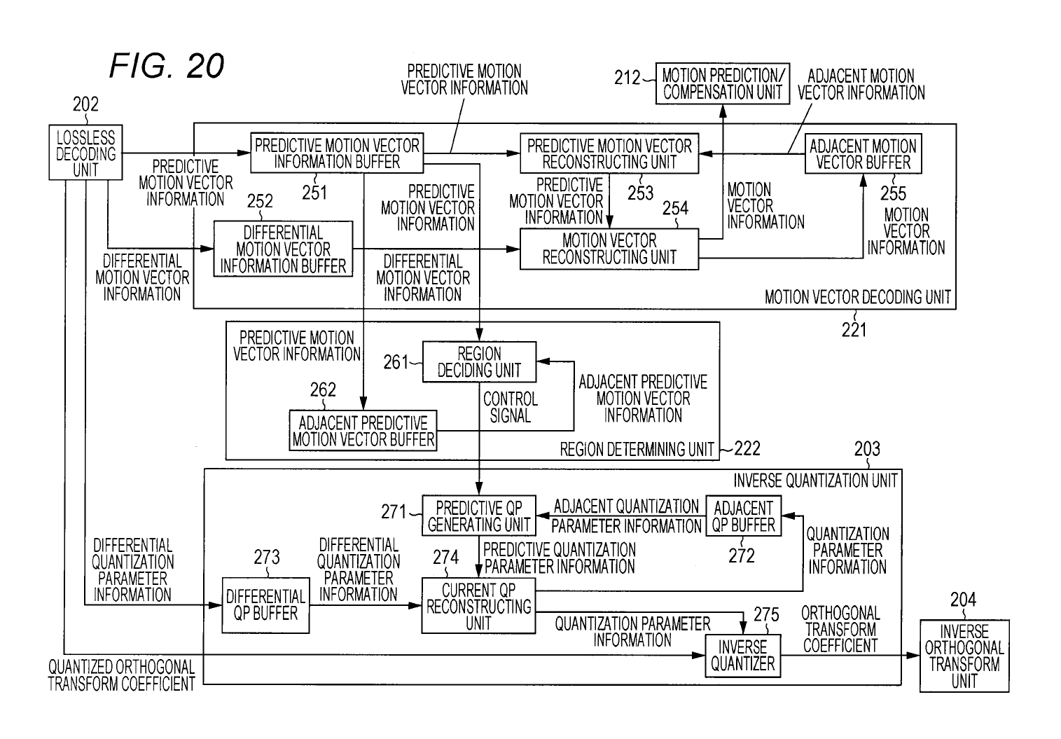

FIG. 20 is a block diagram illustrating an example of main components of the motion vector decoding unit 221, the region determining unit 222, and the inverse quantization unit 203.

In the example of FIG. 20, the motion vector decoding unit 221 is configured to include a predictive motion vector information buffer 251, a differential motion vector information buffer 252, a predictive motion vector reconstructing unit 253, a motion vector reconstructing unit 254, and an adjacent motion vector buffer 255.

The region determining unit 222 is configured to include a region deciding unit 261 and an adjacent predictive motion vector buffer 262.

The inverse quantization unit 203 is configured to include a predictive QP generating unit 271, an adjacent QP buffer 272, a differential QP buffer 273, a current QP reconstructing unit 274, and an inverse quantizer 275.

The predictive motion vector information buffer 251 accumulates the information (hereinafter referred to predictive motion vector information) indicating the index of the predictive motion vector of the target region (PU) decoded by the lossless decoding unit 202. The predictive motion vector information buffer 251 reads the predictive motion vector information of the current PU and supplies the information to the predictive motion vector reconstructing unit 253, the region deciding unit 261, and the adjacent predictive motion vector buffer 262.

The differential motion vector information buffer 252 accumulates the differential motion vector information of the target region (PU) decoded by the lossless decoding unit 202. The differential motion vector information buffer 252 reads the differential motion vector information of the target PU and supplies the information to the motion vector reconstructing unit 254.

The predictive motion vector reconstructing unit 253 reads the motion vector of the adjacent PU indicated by the predictive motion vector information of the target PU supplied from the predictive motion vector information buffer 251 from the adjacent motion vector buffer 255 and reconstructs the predictive motion vector of the target PU. The predictive motion vector reconstructing unit 253 supplies the reconstructed predictive motion vector to the motion vector reconstructing unit 254.

The motion vector reconstructing unit 254 reconstructs the motion vector by adding the differential motion vector of the target PU and the predictive motion vector of the reconstructed predictive motion vector of the target PU and supplies information indicating the reconstructed motion vector to the motion prediction/compensation unit 212.

In line with this, the motion prediction/compensation unit 212 performs inter-prediction using the reference image in the inter-prediction mode indicated by the optimal prediction mode information that is acquired from the lossless decoding unit 202 using the motion vector reconstructed by the motion vector reconstructing unit 254 to generate the predicted image.

When the predictive motion vector information of the current PU is supplied, the region deciding unit 261 reads the predictive motion vector information of the adjacent PUs adjacent to the current PU from the adjacent predictive motion vector buffer 262. The region deciding unit 261 determines a PU (region) referred to for generating the predictive quantization parameter among the adjacent PUs by referring to the predictive motion vector information of the current PU and the predictive motion vector information of the adjacent PUs. The region deciding unit 261 supplies a control signal to the predictive QP generating unit 271 so that the decided PU is referred to.

The adjacent predictive motion vector buffer 262 accumulates the predictive motion vector information supplied from the predictive motion vector information buffer 251 as the information on the adjacent predictive motion vector used for determining the region of the current PU.

The predictive QP generating unit 271 reads the adjacent quantization parameter of the region (the adjacent CU to which the adjacent PU belongs) indicated by the control signal from the region deciding unit 261 from the adjacent QP buffer 272. The predictive QP generating unit 271 uses the read adjacent quantization parameter as the predictive quantization parameter of the current CU and supplies the predictive quantization parameter information of the current CU to the current QP reconstructing unit 274.

The adjacent QP buffer 272 accumulates the information on the quantization parameter reconstructed by the current QP reconstructing unit 274 as the information on the quantization parameter of the adjacent CU adjacent to the current CU, used for generating the predictive quantization parameter of the current CU.

The differential QP buffer 273 acquires the information on the differential quantization parameter decoded by the lossless decoding unit 202 and accumulates the information. The differential QP buffer 273 reads the information on the differential quantization parameter of the current CU and supplies the read information to the current QP reconstructing unit 274.

The current QP reconstructing unit 274 adds the predictive quantization parameter indicated by the information supplied from the predictive QP generating unit 271 and the differential quantization parameter indicated by the information supplied from the differential QP buffer 273 to reconstruct the quantization parameter of the current CU. The current QP reconstructing unit 274 supplies the information on the reconstructed quantization parameter of the current CU to the adjacent QP buffer 272 and the inverse quantizer 275.

The inverse quantizer 275 performs inverse quantization on the quantized orthogonal transform coefficient supplied from the lossless decoding unit 202 using the quantization parameter indicated by the information supplied from the current QP reconstructing unit 274 to obtain the orthogonal transform coefficient and supplies the orthogonal transform coefficient to the inverse orthogonal transform unit 204.

### [Flow of Decoding Process]

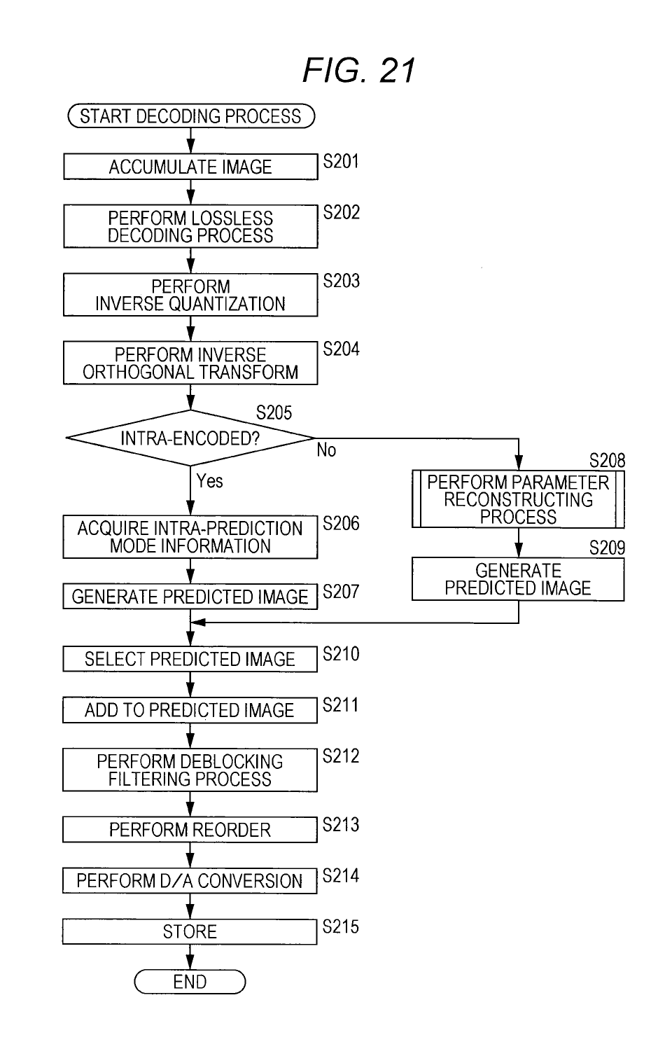

Next, the flow of the respective processes executed by the image decoding device 200 having such a configuration will be described. First, an example of the flow of the decoding process will be described with reference to the flowchart of FIG. 21.

When the decoding process starts, in step S201, the accumulation buffer 201 accumulates the code stream transmitted thereto. In step S202, the lossless decoding unit 202 decodes the code stream (encoded difference image information) supplied from the accumulation buffer 201. That is, the I-picture, P-picture, and B-picture encoded by the lossless encoding unit 106 of FIG. 1 are decoded.

In this case, various types of information other than the difference image information included in the code stream, such as differential motion vector information, a flag indicating the index of a predictive motion vector, and differential quantization parameter information are also decoded.

In step S203, the inverse quantizer 275 of the inverse quantization unit 203 performs inverse quantization on the quantized orthogonal transform coefficients obtained by the process of step S202. In this inverse quantization process, the quantization parameter obtained by the process of step S208 described later is used. In step S204, the inverse orthogonal transform unit 204 performs inverse orthogonal transform on the orthogonal transform coefficients having been subjected to inverse quantization in step S203.

In step S205, the lossless decoding unit 202 determines whether the encoded data to be processed has been subjected to intra-encoding based on the information on the optimal prediction mode decoded in step S202. When it is determined that the encoded data has been subjected to intra-encoding, the flow proceeds to step S206.

In step S206, the intra-prediction unit 211 acquires intra-prediction mode information. In step S207, the intra-prediction unit 211 performs intra-prediction using the intra-prediction mode information acquired in step S206 to generate a predicted image.

Moreover, when it is determined in step S206 that the encoded data to be processed has not been subjected to intra-encoding (that is, the encoded data has been subjected to inter-encoding), the flow proceeds to step S208.

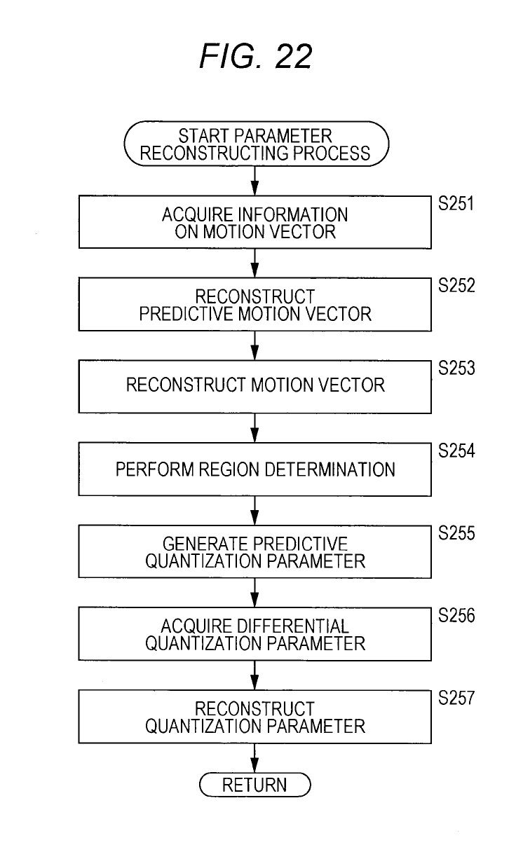

In step S208, the motion vector decoding unit 221, the region determining unit 222, and the inverse quantization unit 203 perform a parameter reconstructing process which is a process of reconstructing motion vectors, quantization parameters, and the like. Details of the parameter reconstructing process will be described with reference to FIG. 22.

With the process of step S208, the predictive motion vector of the current PU and the motion vector are reconstructed by referring to the information on the decoded predictive motion vector. The reconstructed motion vector is supplied to the motion prediction/compensation unit 212.

Moreover, the region referred to for generation of the predictive quantization parameter is determined by referring to the information on the decoded predictive motion vector. The predictive quantization parameter is generated based on the determined region, and the quantization parameter is reconstructed based on the generated predictive quantization parameter and the differential quantization parameter. The reconstructed quantization parameter is supplied to the inverse quantizer 275 and is used for the process of step S203.

In step S209, the motion prediction/compensation unit 212 performs an inter-motion prediction process using the motion vector reconstructed by the process of step S208 to generate a predicted image. The generated predicted image is supplied to the selector 213.

In step S210, the selector 213 selects the predicted image generated in step S207 or S209. In step S211, the arithmetic unit 205 adds the predicted image selected in step S210 to the difference image information obtained through inverse orthogonal transform in step S204. In this manner, the original image is decoded.

In step S212, the deblocking filter 206 appropriately performs a deblocking filtering process with respect to the decoded image obtained in step S211.

In step S213, the screen reorder buffer 207 reorders the image having been filtered in step S212. That is, the screen reorder buffer 102 of the image encoding device 100 reorders the frames arranged in the encoding order by the screen reorder buffer 102 so that the frames are reordered in the original display order.

In step S214, the D/A converter 208 performs D/A conversion on the image in which the frames are reordered in step S213. This image is output to a display (not illustrated) and the image is displayed.

In step S215, the frame memory 209 stores the image having been filtered in step S212.

When the process of step S215 ends, the decoding process ends.

### [Flow of Parameter Reconstructing Process]

Next, an example of the flow of the parameter reconstructing process executed in step S208 of FIG. 21 will be described with reference to the flowchart of FIG. 22. This parameter reconstructing process is a process of reconstructing the motion vectors and the parameters such as the quantization parameters using the information that is transmitted from the encoding side and decoded by the lossless decoding unit 202.

In step S251, the motion vector decoding unit 221 acquires information on the motion vector decoded by the lossless decoding unit 202 in step S202 of FIG. 21. That is, the predictive motion vector information buffer 251 acquires information indicating the index of the predictive motion vector which is one of the items of information on the motion vector and accumulates the information. The differential motion vector information buffer 252 acquires information indicating the value of the differential motion vector which is one of the items of information on the motion vector and accumulates the information.

In step S252, the predictive motion vector reconstructing unit 253 reconstructs the predictive motion vector of the target PU. That is, the index of the predictive motion vector of the target PU is supplied from the predictive motion vector information buffer 251. In line with this, the predictive motion vector reconstructing unit 253 reads the motion vector of the adjacent PU indicated by the index of the predictive motion vector of the target PU from the adjacent motion vector buffer 255 and reconstructs the predictive motion vector of the target PU. The reconstructed predictive motion vector of the target PU is supplied to the motion vector reconstructing unit 254.

In step S253, the motion vector reconstructing unit 254 reconstructs the motion vector of the current PU. That is, the information indicating the value of the differential motion vector of the target PU is supplied from the differential motion vector information buffer 252. The motion vector reconstructing unit 254 reconstructs the motion vector of the current PU by adding the differential motion vector of the target PU of the differential motion vector information buffer 252 and the predictive motion vector supplied from the predictive motion vector reconstructing unit 253. The information indicating the reconstructed motion vector of the current PU is supplied to the motion prediction/compensation unit 212 and is used for the predicted image generating process of step S209 of FIG. 21.

The predictive motion vector information acquired in step S251 is also supplied to the region deciding unit 261 and the adjacent predictive motion vector buffer 262. In line with this, the region deciding unit 261 reads the information on the predictive motion vector of the adjacent PU adjacent to the current PU from the adjacent predictive motion vector buffer 262.

In step S254, the region deciding unit 261 performs region determination as described above with reference to FIGS. 13 to 15. That is, the region deciding unit 261 decides a PU (region) referred to for generating the predictive quantization parameter among the adjacent PUs by referring to the information on the predictive motion vector of the current PU and the information on the predictive motion vector of the adjacent PUs. The region deciding unit 261 supplies a control signal to the predictive QP generating unit 271 so that the decided PU is referred to.

In step S255, the predictive QP generating unit 271 reads the adjacent quantization parameter of a region (an adjacent CU to which the adjacent PU belongs) indicated by the control signal from the region deciding unit 261 from the adjacent QP buffer 272 and generates the predictive quantization parameter of the current CU using the adjacent quantization parameter. The information indicating the generated predictive quantization parameter of the current CU is supplied to the current QP reconstructing unit 274.

In step S256, the differential QP buffer 273 acquires the information indicating the differential quantization parameter decoded by the lossless decoding unit 202 in step S202 of FIG. 21. The differential QP buffer 273 reads the information on the differential quantization parameter of the current CU and supplies the read information to the current QP reconstructing unit 274.

In step S257, the current QP reconstructing unit 274 adds the predictive quantization parameter indicated by the information supplied from the predictive QP generating unit 271 and the differential quantization parameter indicated by the information supplied from the differential QP buffer 273 to reconstruct the quantization parameter of the current CU. The reconstructed quantization parameter of the current CU is supplied to the inverse quantizer 275 and is used for the inverse quantization process of step S203 of FIG. 21.

By performing the respective processes in this manner, the image decoding device 200 can correctly decode the encoded data encoded by the image encoding device 100 and improve the encoding efficiency.

That is, in the image decoding device 200, since adjacent regions having the same predictive motion vector as the processing target region are referred to for generating the predictive quantization parameter of the processing target region, it is possible to improve the encoding efficiency of the differential quantization parameter.

That is, the differential quantization parameter is generated by referring to the predictive motion vector generated in the MV competition or merge mode, and the encoding efficiency can be improved.

As above, regions are classified depending on whether the current region and the adjacent regions are encoded using the spatial predictive motion vector or the temporal predictive motion vector, and the prediction process for encoding the quantization parameter is performed according to the classification result. Thus, it is possible to improve the encoding efficiency.

In the above description, although the case pursuant to the HEVC scheme has been described as an example, this technique can be applied to devices that use another encoding scheme as long as the devices perform the motion vector information encoding process and decoding process according to the MV competition and merge modes.

This technique can be applied to an image information encoding device and an image decoding method that are used when image information (a bit stream) which has been compressed by orthogonal transform such as discrete cosine transform and motion compensation as in the case of MPEG, H.26x, and the like is received via a network medium such as satellite broadcasting, a cable TV, the Internet, or a cellular phone. Moreover, this technique can be applied to an image encoding device and an image decoding device that are used when the image information (bit stream) is processed on a storage medium such as an optical or magnetic disk, or a flash memory. Further, this technique can be applied to a motion prediction compensating device included in the image encoding device, the image decoding device, and the like.

### 3. Third Embodiment

### Application to Multi-View Image Encoding and Decoding

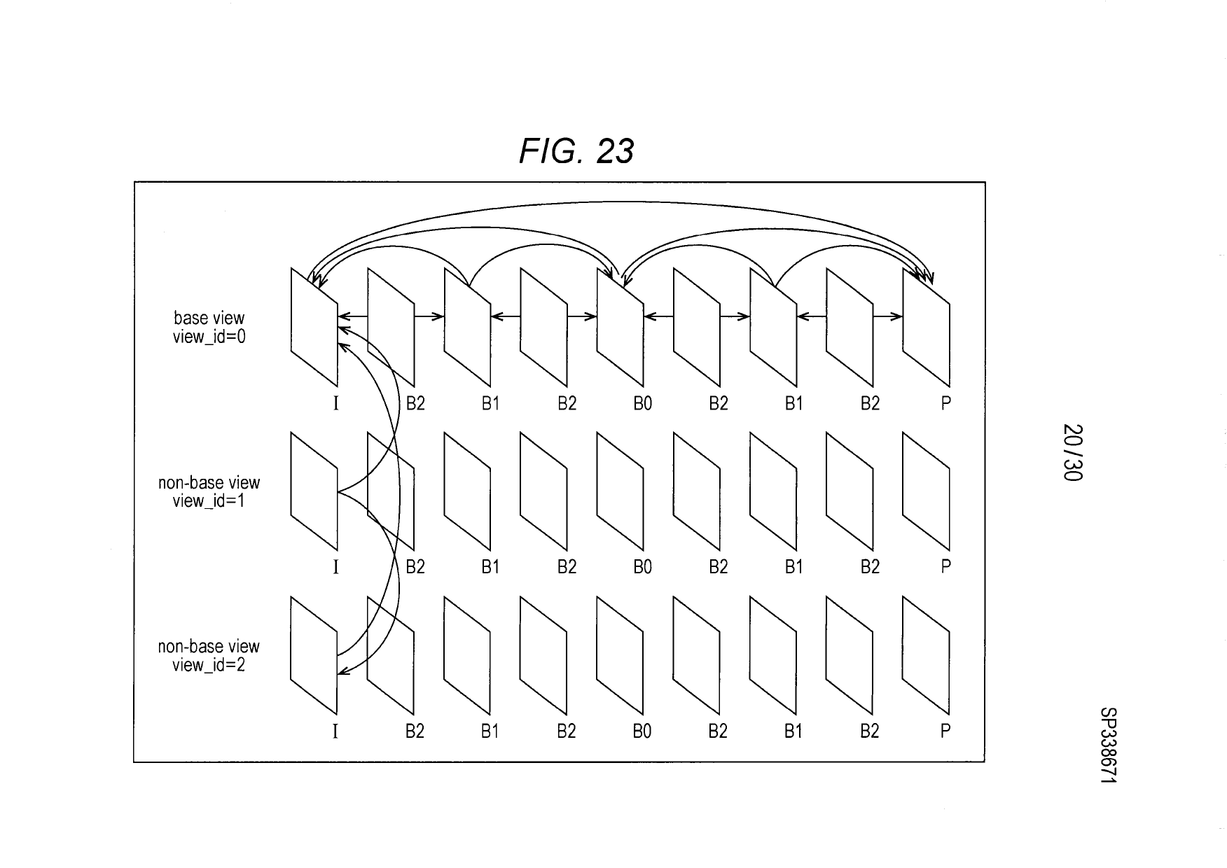

The series of processes can be applied to multi-view image encoding and decoding. FIG. 23 illustrates an example of a multi-view image encoding scheme.

As illustrated in FIG. 23, a multi-view image includes images of a plurality of views, and an image of a predetermined single view among the plurality of views is designated as a base view image. The respective view images other than the base view image are treated as non-base view images.

When the multi-view image as illustrated in FIG. 23 is encoded, a difference between the quantization parameters in the respective views (same views) may be taken:

(1)base-view:

dQP(base view)=CurrentQP(base view)−LeftQP(base view) or TopQP(base view)

(2)non-base-view:

dQP(non-base view)=CurrentQP(non-base view)−LeftQP(non-base view) or TopQP(non-base view)

Here, dQP represents a difference value (cu_qp_delta) between a quantization parameter and a quantization parameter (predictive quantization parameter), and CurrentQP is a quantization parameter of a processing target coding unit (CU). Any one of LeftQP and TopQP is used as the predictive quantization parameter. LeftQP represents a quantization parameter of a left CU spatially adjacent to the left of the current processing target CU, and TopQP represents a quantization parameter of a top CU spatially adjacent to the top of the current processing target CU.

In dQP, whether the predictive quantization parameter is LeftQP or TopQP is determined depending on a prediction method used for generating the predictive motion vectors in the current CU, the left CU, and the top CU, as described above. That is, the quantization parameter of a CU (left CU or top CU) that is considered to belong to the same region as the current CU is used as the predictive quantization parameter of the current CU.

Moreover, the multi-view image is encoded, a difference between the quantization parameters in the respective views (different views) may be taken:

(3)base-view/non-base view:

dQP(inter-view)=CurrentQP(base view)−CurrentQP(non-base view) (3-1)

dQP(inter-view)=CurrentQP(base view)−LeftQP(non-base view) or TopQP(non-base view) (3-2)

(4)non-base view/non-base view:

dQP(inter-view)=CurrentQP(non-base view i)−CurrentQP(non-base view j) (4-1)

dQP(inter-view)=CurrentQP(non-base view i)−LeftQP(non-base view j) or TopQP(non-base view j) (4-2)

In this way, the quantization parameter of a CU (left CU or top CU) that is considered to belong to the same region as the current CU is used as the predictive quantization parameter of the current CU and a difference is generated. In this way, it is possible to improve the encoding efficiency even when layered encoding is performed.

[Multi-View Image Encoding Device]

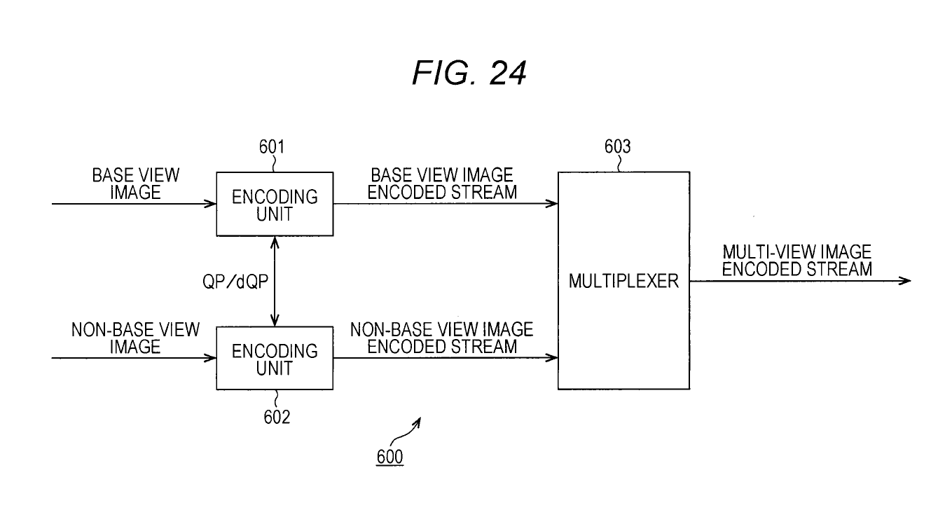

FIG. 24 is a diagram illustrating a multi-view image encoding device that performs the multi-view image encoding described above. As illustrated in FIG. 24, a multi-view image encoding device 600 includes an encoding unit 601, an encoding unit 602, and a multiplexer 603.

The encoding unit 601 encodes a base view image to generate a base view image encoded stream. The encoding unit 602 encodes a non-base view image to generate a non-base view image encoded stream. The multiplexer 603 multiplexes the base view image encoded stream generated by the encoding unit 601 and the non-base view image encoded stream generated by the encoding unit 602 to generate a multi-view image encoded stream.

The image encoding device 100 (FIG. 1) can be applied to the encoding units 601 and 602 of the multi-view image encoding device 600. In this case, the multi-view image encoding device 600 sets a difference value between the quantization parameters set by the encoding unit 601 and the quantization parameters set by the encoding unit 602 and transmits the difference value.

[Multi-View Image Decoding Device]

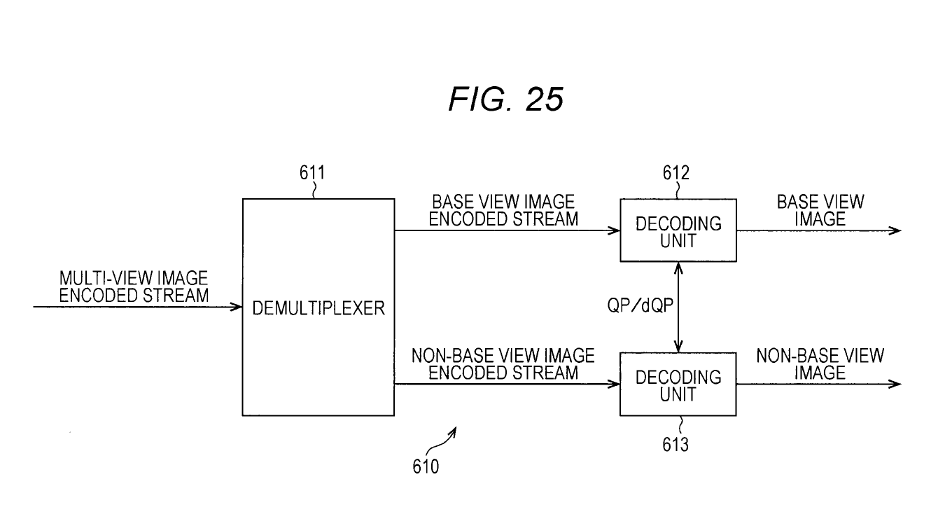

FIG. 25 is a diagram illustrating a multi-view image decoding device that performs the multi-view image decoding described above. As illustrated in FIG. 25, a multi-view image decoding device 610 includes a demultiplexer 611, a decoding unit 612, and a decoding unit 613.

The demultiplexer 611 demultiplexes the multi-view image encoded stream in which the base view image encoded stream and the non-base view image encoded stream are multiplexed to extract the base view image encoded stream and the non-base view image encoded stream. The decoding unit 612 decodes the base view image encoded stream extracted by the demultiplexer 611 to obtain a base view image. The decoding unit 613 decodes the non-base view image encoded stream extracted by the demultiplexer 611 to obtain a non-base view image.

The image decoding device 200 (FIG. 19) can be applied to the decoding units 612 and 613 of the multi-view image decoding device 610. In this case, the multi-view image decoding device 610 sets the quantization parameter from the difference value between the quantization parameter set by the encoding unit 601 and the quantization parameter set by the encoding unit 602 and performs inverse quantization.

### 4. Fourth Embodiment

### Application to Layer Image Encoding and Decoding

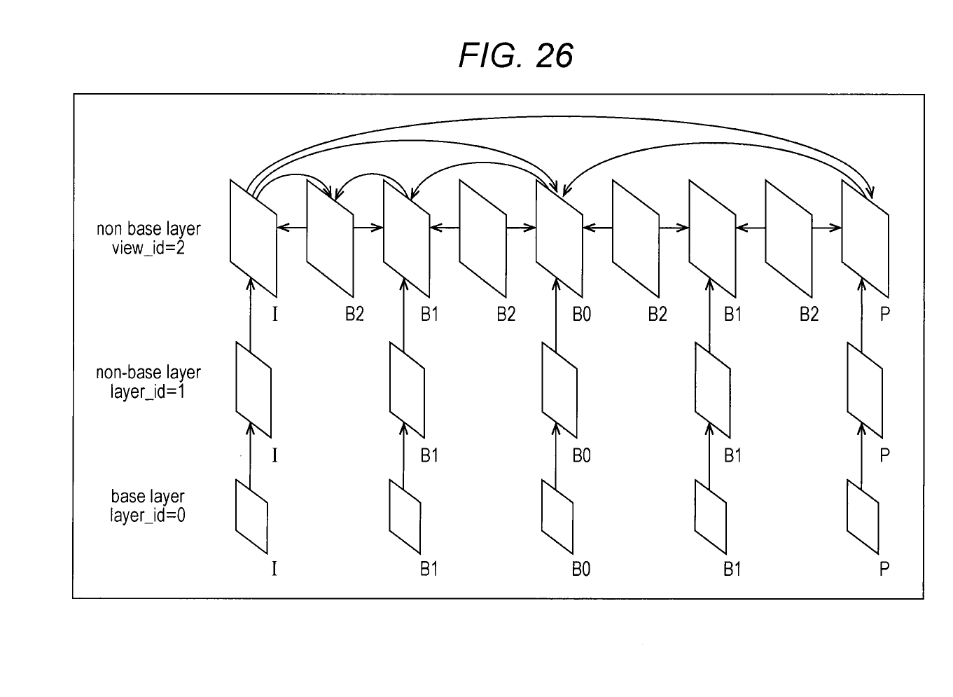

The above series of processes can be applied to layer image encoding and decoding. FIG. 26 illustrates an example of a multi-view image encoding scheme.

As illustrated in FIG. 26, a layer image includes images of a plurality of layers (resolutions), and an image of a predetermined single layer among the plurality of resolutions is designated as a base layer image. The respective layer images other than the base layer image are treated as non-base layer images.

When the layer image encoding (space scalability) as illustrated in FIG. 26 is performed, a difference value between quantization parameters in the respective layers (same layers) may be taken.

(1)base-layer:

dQP(base layer)=CurrentQP(base layer)−LeftQP(base layer) or TopQP(base layer)

(2)non-base-view:

dQP(non-base layer)=CurrentQP(non-base layer)−LeftQP(non-base layer) or TopQP(non-base layer)

Here, dQP represents a difference value (cu_qp_delta) between a quantization parameter and a quantization parameter (predictive quantization parameter), and CurrentQP is a quantization parameter of a processing target coding unit (CU). Any one of LeftQP and TopQP is used as the predictive quantization parameter. LeftQP represents a quantization parameter of a left CU spatially adjacent to the left of the current processing target CU, and TopQP represents a quantization parameter of a top CU spatially adjacent to the top of the current processing target CU.

In dQP, whether the predictive quantization parameter is LeftQP or TopQP is determined depending on a prediction method used for generating the predictive motion vectors in the current CU, the left CU, and the top CU, as described above. That is, the quantization parameter of a CU (left CU or top CU) that is considered to belong to the same region as the current CU is used as the predictive quantization parameter of the current CU.

Moreover, when the layer image encoding (space scalability) is performed, a difference value between quantization parameters in the respective views (different views) may be taken.

(3)base-layer/non-base layer:

dQP(inter-layer)=CurrentQP(base layer)−CurrentQP(non-base layer) (3-1)

dQP(inter-layer)=CurrentQP(base layer)−LeftQP(non-base layer) or TopQP(non-base layer) (3-2)

(4)non-base layer/non-base layer:

dQP(inter-layer)=CurrentQP(non-base layer i)−CurrentQP(non-base layer j) (4-1)

dQP(inter-view)=CurrentQP(non-base layer i)−LeftQP(non-base layer j) or TopQP(non-base layer j) (4-2)

In this way, the quantization parameter of a CU (left CU or top CU) that is considered to belong to the same region as the current CU is used as the predictive quantization parameter of the current CU and a difference is generated. In this way, it is possible to improve the encoding efficiency even when layered encoding is performed.

[Layer Image Encoding Device]

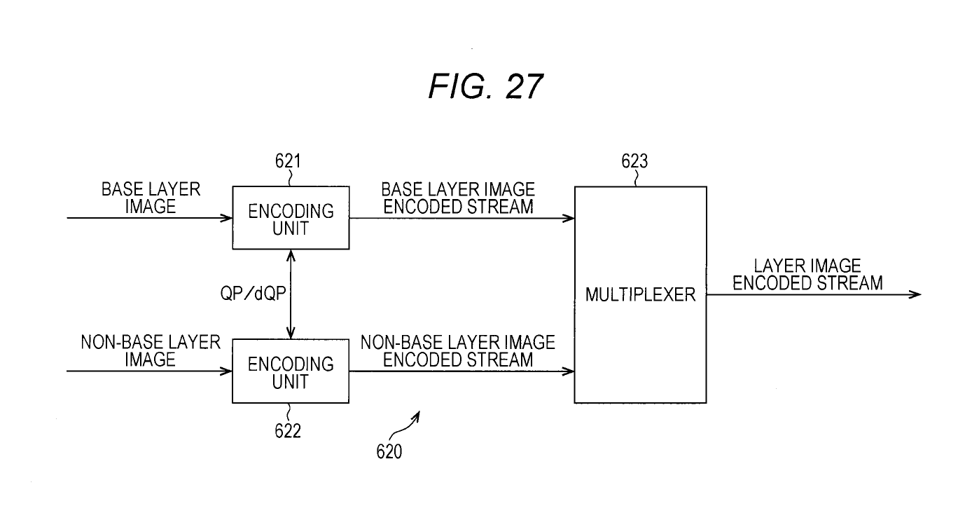

FIG. 27 is a diagram illustrating a layer image encoding device that performs the layer image encoding described above. As illustrated in FIG. 27, a layer image encoding device 620 includes an encoding unit 621, an encoding unit 622, and a multiplexer 623.

The encoding unit 621 encodes a base layer image to generate a base layer image encoded stream. The encoding unit 622 encodes a non-base layer image to generate a non-base layer image encoded stream. The multiplexer 623 multiplexes the base layer image encoded stream generated by the encoding unit 621 and the non-base layer image encoded stream generated by the encoding unit 622 to generate a layer image encoded stream.

The image encoding device 100 (FIG. 1) can be applied to the encoding units 621 and 622 of the layer image encoding device 620. In this case, the layer image encoding device 620 sets a difference value between the quantization parameter set by the encoding unit 621 and the quantization parameter set by the encoding unit 622 and transmits the difference value.

[Layer Image Decoding Device]

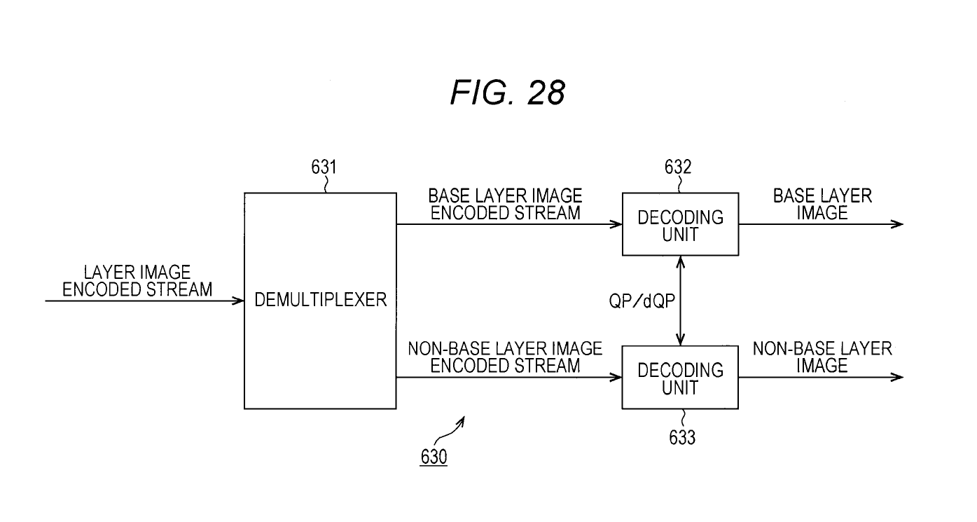

FIG. 28 is a diagram illustrating a layer image decoding device that performs the layer image decoding described above. As illustrated in FIG. 28, a layer image decoding device 630 includes a demultiplexer 631, a decoding unit 632, and a decoding unit 633.

The demultiplexer 631 demultiplexes the layer image encoded stream in which the base layer image encoded stream and the non-base layer image encoded stream are multiplexed to extract the base layer image encoded stream and the non-base layer image encoded stream. The decoding unit 632 decodes the base layer image encoded stream extracted by the demultiplexer 631 to obtain a base layer image. The decoding unit 633 decodes the non-base layer image encoded stream extracted by the demultiplexer 631 to obtain a non-base layer image.

The image decoding device 200 (FIG. 19) can be applied to the decoding units 632 and 633 of the multi-view image decoding device 630. In this case, the layer image decoding device 630 sets a quantization parameter from the difference value between the quantization parameter set by the encoding unit 621 and the quantization parameter set by the encoding unit 622 and performs inverse quantization.

### 5. Fifth Embodiment

### Computer

The above-described series of processes can be executed not only by hardware but also by software. When the series of processes are executed by software, a program included in the software is installed in a computer. Here, the computer may be a computer integrated into an exclusive hardware or a general-purpose personal computer which can execute various functions by installing various programs in the computer.

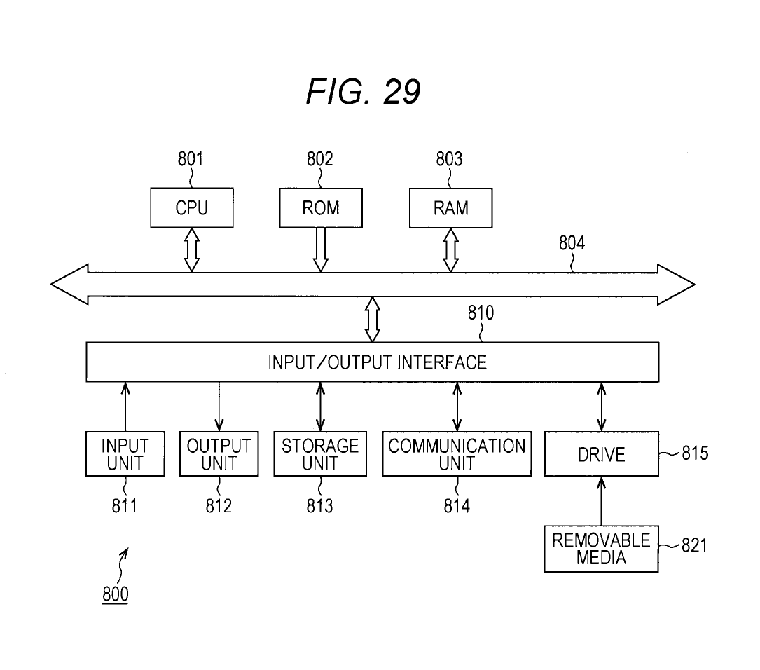

FIG. 29 is a block diagram illustrating an example of a hardware configuration of a computer that executes the above-described series of processes according to a program.

In a computer 800, a central processing unit (CPU) 801, a read only memory (ROM) 802, and a random access memory (RAM) 803 are connected to one another by a bus 804.

An input/output interface 805 is also connected to the bus 804. An input unit 806, an output unit 807, a storage unit 808, a communication unit 809, and a drive 810 are connected to the input/output interface 805.

The input unit 806 is formed of a keyboard, a mouse, a microphone, and the like. The output unit 807 is formed of a display, a speaker, and the like. The storage unit 808 is formed of a hard disk, a nonvolatile memory, and the like. The communication unit 809 is formed of a network interface and the like. The drive 810 drives a removable medium 811 such as a magnetic disk, an optical disc, a magneto-optical disc, or a semiconductor memory.

In the computer having the above-described configuration, the CPU 801 loads the program stored in the storage unit 808, for example, into the RAM 803 with the aid of the input/output interface 805 and the bus 804 and executes the program, whereby the above-described series of processes are performed.

The program executed by the computer 800 (the CPU 801) can be provided by being recorded on the removable medium 811 as a package medium or the like, for example. Moreover, the program may be provided via a cable or wireless transmission medium such as a local area communication network, the Internet, or digital satellite broadcasting.

In the computer, the program may be installed in the storage unit 808 via the input/output interface 805 by mounting the removable medium 811 on the drive 810. Moreover, the program may be received by the communication unit 809 via a cable or wireless transmission medium and be installed in the storage unit 808. Further, the program may be installed in advance in the ROM 802 or the storage unit 808.

The program executed by the computer may be a program executing processing in a time-sequential manner in accordance with the procedures described in this specification and may be a program executing the processing in a parallel manner or at necessary times such as in response to calls.

Here, in this specification, the steps that describe the program recorded in the recording medium include not only processing which is executed in time-sequential manner in accordance with described procedures but also processing which is executed in parallel and/or separately even if it is not always executed in time-sequential manner.

In this specification, the term “system” is used to imply an apparatus as a whole, which includes a plurality of devices (apparatuses).

In the above description, the configuration described as one apparatus (or processor) may be split into a plurality of apparatuses (or processors). Alternatively, the configuration described as a plurality of apparatuses (or processors) may be integrated into a single apparatus (or processor). Moreover, a configuration other than those discussed above may be included in the above-described configuration of each apparatus (or each processor). If the configuration and the operation of a system as a whole is substantially the same, part of the configuration of an apparatus (or processor) may be added to the configuration of another apparatus (or another processor). This technique is not limited to the above-described embodiments, but various modifications can be made in a range not departing from the gist of this technique.

The image encoding device and the image decoding device according to the above-described embodiments can be applied to various electronic apparatuses such as a transmitter or a receiver that distributes signals on cable broadcasting (such as satellite broadcasting or a cable TV) or on the Internet and distributes signals to a terminal by cellular communication, a recording device that records images on a medium such as an optical disc, a magnetic disk, or a flash memory, or a reproducing device that reproduces images from these storage media. Four application examples will be described below.

### 6. Application Example

### First Application Example

### Television Apparatus

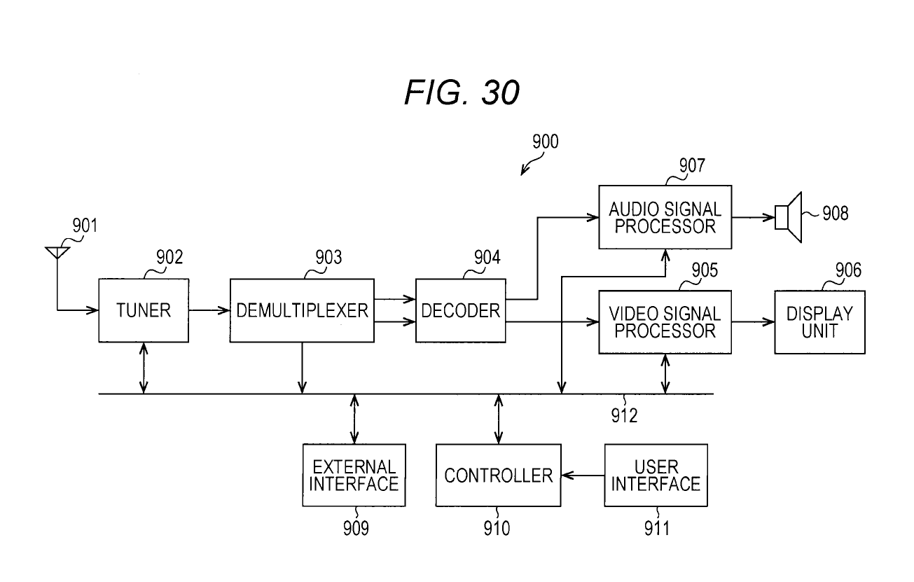

FIG. 30 illustrates an example of a schematic configuration of a television apparatus to which the above-described embodiment is applied. A television apparatus 900 includes an antenna 901, a tuner 902, a demultiplexer 903, a decoder 904, a video signal processor 905, a display unit 906, an audio signal processor 907, a speaker 908, an external interface 909, a controller 910, a user interface 911, and a bus 912.

The tuner 902 extracts a signal of a desired channel from a broadcast signal received through the antenna 901 and demodulates the extracted signal. Then, the tuner 902 outputs an encoded bit stream obtained by demodulation to the demultiplexer 903. That is, the tuner 902 serves as a transmitting unit in the television apparatus 900, which receives the encoded stream in which the image is encoded.

The demultiplexer 903 separates a video stream and an audio stream of a program to be watched from the encoded bit stream and outputs each separated stream to the decoder 904. Moreover, the demultiplexer 903 extracts auxiliary data such as EPG (Electronic Program Guide) from the encoded bit stream and supplies the extracted data to the controller 910. The demultiplexer 903 may descramble when the encoded bit stream is scrambled.

The decoder 904 decodes the video stream and the audio stream input from the demultiplexer 903. Then, the decoder 904 outputs video data generated by a decoding process to the video signal processor 905. Moreover, the decoder 904 outputs audio data generated by the decoding process to the audio signal processor 907.

The video signal processor 905 reproduces the video data input from the decoder 904 and allows the display unit 906 to display video. The video signal processor 905 may also allow the display unit 906 to display an application screen supplied through the network. The video signal processor 905 may also perform an additional process such as noise removal, for example, to the video data according to setting. Further, the video signal processor 905 may generate a GUI (Graphical User Interface) image such as a menu, a button, and a cursor, for example, and superimpose the generated image on an output image.

The display unit 906 is driven by a drive signal supplied from the video signal processor 905 to display the video or image on a video screen of a display device (for example, a liquid crystal display, a plasma display, an OELD (Organic ElectroLuminescence Display (organic EL display) and the like).

The audio signal processor 907 performs a reproducing process such as D/A conversion and amplification to the audio data input from the decoder 904 and allows the speaker 908 to output the audio. The audio signal processor 907 may also perform an additional process such as the noise removal to the audio data.

The external interface 909 is the interface for connecting the television apparatus 900 and an external device or the network. For example, the video stream or the audio stream received via the external interface 909 may be decoded by the decoder 904. That is, the external interface 909 also serves as the transmitting unit in the television apparatus 900, which receives the encoded stream in which the image is encoded.

The controller 910 includes a processor such as a CPU and a memory such as a RAM and a ROM. The memory stores the program executed by the CPU, program data, the EPG data, data obtained through the network and the like. The program stored in the memory is read by the CPU at startup of the television apparatus 900 to be executed, for example. The CPU controls operation of the television apparatus 900 according to an operation signal input from the user interface 911, for example, by executing the program.

The user interface 911 is connected to the controller 910. The user interface 911 includes a button and a switch for the user to operate the television apparatus 900, a receiver of a remote control signal and the like, for example. The user interface 911 detects operation by the user through the components to generate the operation signal and outputs the generated operation signal to the controller 910.

The bus 912 connects the tuner 902, the demultiplexer 903, the decoder 904, the video signal processor 905, the audio signal processor 907, the external interface 909, and the controller 910 to one another.

In the television apparatus 900 configured in this manner, the decoder 904 has the functions of the image decoding device according to the above-described embodiment. Therefore, it is possible to improve encoding efficiency when images are decoded in the television apparatus 900.

### Second Application Example

### Mobile Phone

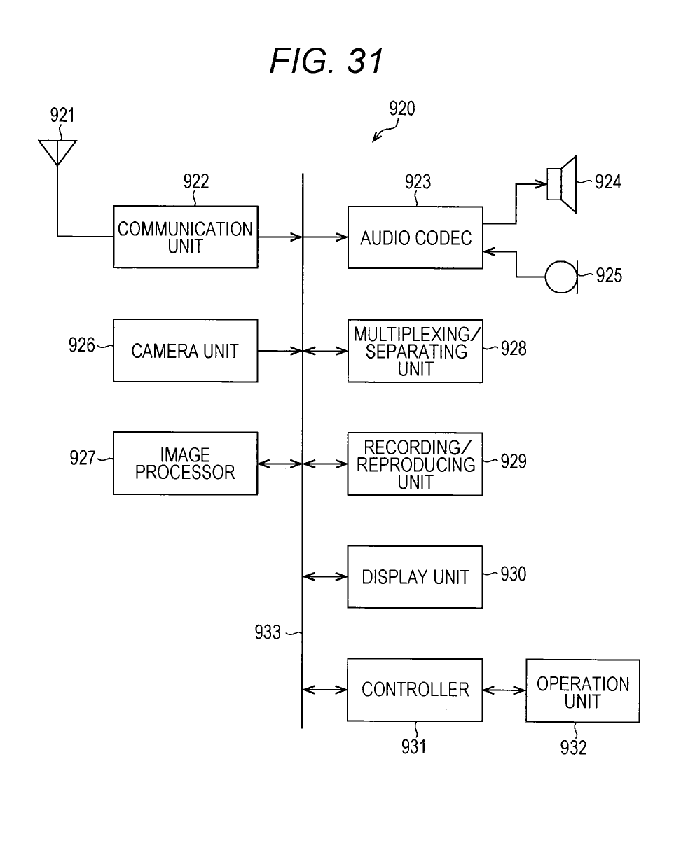

FIG. 31 illustrates an example of a schematic configuration of a mobile phone to which the above-described embodiment is applied. A mobile phone 920 includes an antenna 921, a communication unit 922, an audio codec 923, a speaker 924, a microphone 925, a camera unit 926, an image processor 927, a multiplexing/separating unit 928, a recording/reproducing unit 929, a display unit 930, a controller 931, an operation unit 932, and a bus 933.

The antenna 921 is connected to the communication unit 922. The speaker 924 and the microphone 925 are connected to the audio codec 923. The operation unit 932 is connected to the controller 931. The bus 933 connects the communication unit 922, the audio codec 923, the camera unit 926, the image processor 927, the multiplexing/separating unit 928, the recording/reproducing unit 929, the display unit 930, and the controller 931 to one another.

The mobile phone 920 performs operation such as transmission/reception of an audio signal, transmission/reception of an e-mail or image data, image taking, and recording of data in various operation modes including an audio communication mode, a data communication mode, an imaging mode, and a television-phone mode.

In the audio communication mode, an analog audio signal generated by the microphone 925 is supplied to the audio codec 923. The audio codec 923 converts the analog audio signal to the audio data and A/D converts the converted audio data to compress. Then, the audio codec 923 outputs the compressed audio data to the communication unit 922. The communication unit 922 encodes and modulates the audio data to generate a transmission signal. Then, the communication unit 922 transmits the generated transmission signal to a base station (not illustrated) via the antenna 921. Moreover, the communication unit 922 amplifies a wireless signal received via the antenna 921 and applies frequency conversion to the same to obtain a reception signal. Then, the communication unit 922 generates the audio data by demodulating and decoding the reception signal and outputs the generated audio data to the audio codec 923. The audio codec 923 expands the audio data and D/A converts the same to generate the analog audio signal. Then, the audio codec 923 supplies the generated audio signal to the speaker 924 to allow the same to output the audio.

In the data communication mode, for example, the controller 931 generates character data composing the e-mail according to the operation by the user through the operation unit 932. Moreover, the controller 931 allows the display unit 930 to display characters. The controller 931 generates e-mail data according to a transmission instruction from the user through the operation unit 932 to output the generated e-mail data to the communication unit 922. The communication unit 922 encodes and modulates the e-mail data to generate the transmission signal. Then, the communication unit 922 transmits the generated transmission signal to a base station (not illustrated) via the antenna 921. Moreover, the communication unit 922 amplifies a wireless signal received via the antenna 921 and applies frequency conversion to the same to obtain a reception signal. Then, the communication unit 922 demodulates and decodes the reception signal to restore the e-mail data and outputs the restored e-mail data to the controller 931. The controller 931 allows the display unit 930 to display contents of the e-mail data and allows the storage medium of the recording/reproducing unit 929 to store the e-mail data.

The recording/reproducing unit 929 includes an arbitrary readable/writable storage medium. For example, the storage medium may be a built-in storage medium such as the RAM and the flash memory and may be an externally-mounted storage medium such as the hard disk, the magnetic disc, the magneto-optical disc, the optical disc, a USB (Unallocated Space Bitmap) memory, and a memory card.

In the imaging mode, for example, the camera unit 926 takes an image of an object to generate the image data and outputs the generated image data to the image processor 927. The image processor 927 encodes the image data input from the camera unit 926 and stores the encoded stream in the storage medium of the recording/reproducing unit 929.

Moreover, in the television-phone mode, for example, the multiplexing/separating unit 928 multiplexes the video stream encoded by the image processor 927 and the audio stream input from the audio codec 923 and outputs the multiplexed stream to the communication unit 922. The communication unit 922 encodes and modulates the stream to generate the transmission signal. Then, the communication unit 922 transmits the generated transmission signal to a base station (not illustrated) via the antenna 921. Moreover, the communication unit 922 amplifies a wireless signal received via the antenna 921 and applies frequency conversion to the same to obtain a reception signal. The transmission signal and the reception signal may include the encoded bit stream. Then, the communication unit 922 restores the stream by demodulating and decoding the reception signal and outputs the restored stream to the multiplexing/separating unit 928. The multiplexing/separating unit 928 separates the video stream and the audio stream from the input stream and outputs the video stream and the audio stream to the image processor 927 and the audio codec 923, respectively. The image processor 927 decodes the video stream to generate the video data. The video data is supplied to the display unit 930 and a series of images is displayed by the display unit 930. The audio codec 923 expands the audio stream and D/A converts the same to generate the analog audio signal. Then, the audio codec 923 supplies the generated audio signal to the speaker 924 to allow the same to output the audio.

In the mobile phone 920 configured in this manner, the image processor 927 has the functions of the image encoding device and the image decoding device according to the above-described embodiment. Therefore, when images are encoded and decoded in the mobile phone 920, the encoding efficiency can be improved.

### Third Application Example

### Recording/Reproducing Apparatus

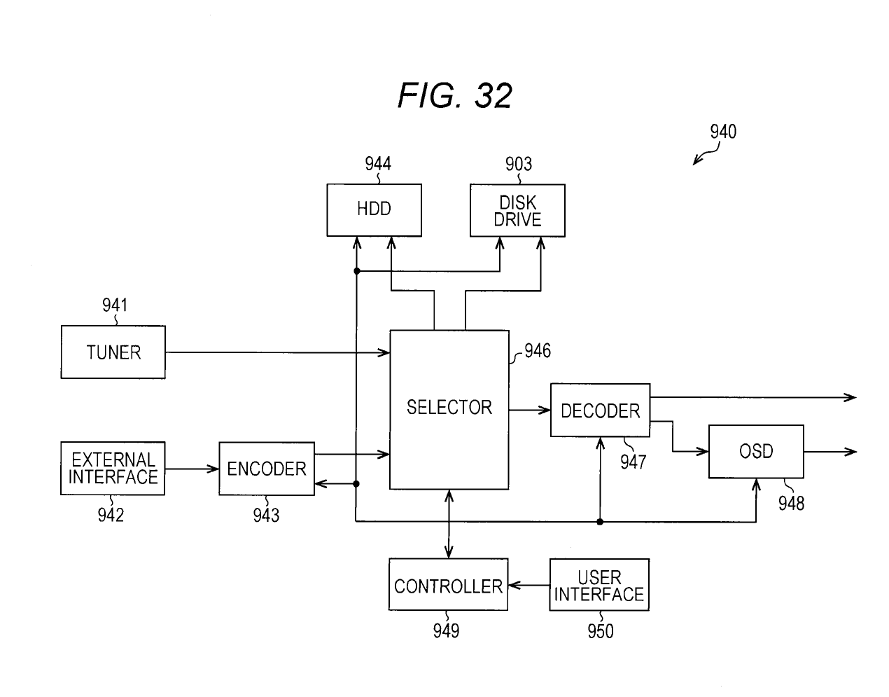

FIG. 32 illustrates an example of a schematic configuration of the recording/reproducing device to which the above-described embodiment is applied. The recording/reproducing device 940 encodes the audio data and the video data of a received broadcast program to record on the recording medium, for example. Moreover, the recording/reproducing device 940 may encode the audio data and the video data obtained from another apparatus to record on the recording medium, for example. Moreover, the recording/reproducing device 940 reproduces the data recorded on the recording medium by a monitor and the speaker according to the instruction of the user. In this case, the recording/reproducing device 940 decodes the audio data and the video data.

The recording/reproducing device 940 includes a tuner 941, an external interface 942, an encoder 943, a HDD (Hard Disk Drive) 944, a disc drive 945, a selector 946, a decoder 947, an OSD (On-Screen Display) 948, a controller 949, and a user interface 950.

The tuner 941 extracts a signal of a desired channel from the broadcast signal received through an antenna (not illustrated) and demodulates the extracted signal. Then, the tuner 941 outputs the encoded bit stream obtained by the demodulation to the selector 946. That is, the tuner 941 serves as the transmitting unit in the recording/reproducing device 940.

The external interface 942 is the interface for connecting the recording/reproducing device 940 and the external device or the network. The external interface 942 may be an IEEE1394 interface, a network interface, a USB interface, a flash memory interface and the like, for example. For example, the video data and the audio data received via the external interface 942 are input to the encoder 943. That is, the external interface 942 serves as the transmitting unit in the recording/reproducing device 940.

The encoder 943 encodes the video data and the audio data when the video data and the audio data input from the external interface 942 are not encoded. Then, the encoder 943 outputs the encoded bit stream to the selector 946.

The HDD 944 records the encoded bit stream in which content data such as the video and the audio are compressed, various programs and other data on an internal hard disk. The HDD 944 reads the data from the hard disk when reproducing the video and the audio.

The disc drive 945 records and reads the data on and from the mounted recording medium. The recording medium mounted on the disc drive 945 may be the DVD disc (DVD-Video, DVD-RAM, DVD-R, DVD-RW, DVD+R, DVD+RW and the like), a Blu-ray (registered trademark) disc and the like, for example.

The selector 946 selects the encoded bit stream input from the tuner 941 or the encoder 943 and outputs the selected encoded bit stream to the HDD 944 or the disc drive 945 when recording the video and the audio. Moreover, the selector 946 outputs the encoded bit stream input from the HDD 944 or the disc drive 945 to the decoder 947 when reproducing the video and the audio.

The decoder 947 decodes the encoded bit stream to generate the video data and the audio data. Then, the decoder 947 outputs the generated video data to the OSD 948. Moreover, the decoder 904 outputs the generated audio data to an external speaker.

The OSD 948 reproduces the video data input from the decoder 947 to display the video. The OSD 948 may also superimpose the GUI image such as the menu, the button, and the cursor, for example, on the displayed video.

The controller 949 includes the processor such as the CPU and the memory such as the RAM and ROM. The memory stores the program executed by the CPU, the program data and the like. The program stored in the memory is read by the CPU to be executed on activation of the recording/reproducing device 940, for example. The CPU controls operation of the recording/reproducing device 940 according to an operation signal input from the user interface 950, for example, by executing the program.

The user interface 950 is connected to the controller 949. The user interface 950 includes a button and a switch for the user to operate the recording/reproducing device 940 and a receiver of a remote control signal, for example. The user interface 950 detects operation by the user via the components to generate the operation signal and outputs the generated operation signal to the controller 949.

In the recording/reproducing device 940 configured in this manner, the encoder 943 has the functions of the image encoding device according to the above-described embodiment. Moreover, the decoder 947 has the functions of the image decoding device according to the above-described embodiment. Therefore, when images are encoded and decoded in the recording/reproducing device 940, the encoding efficiency can be improved.

### Fourth Application Example

### Imaging Device

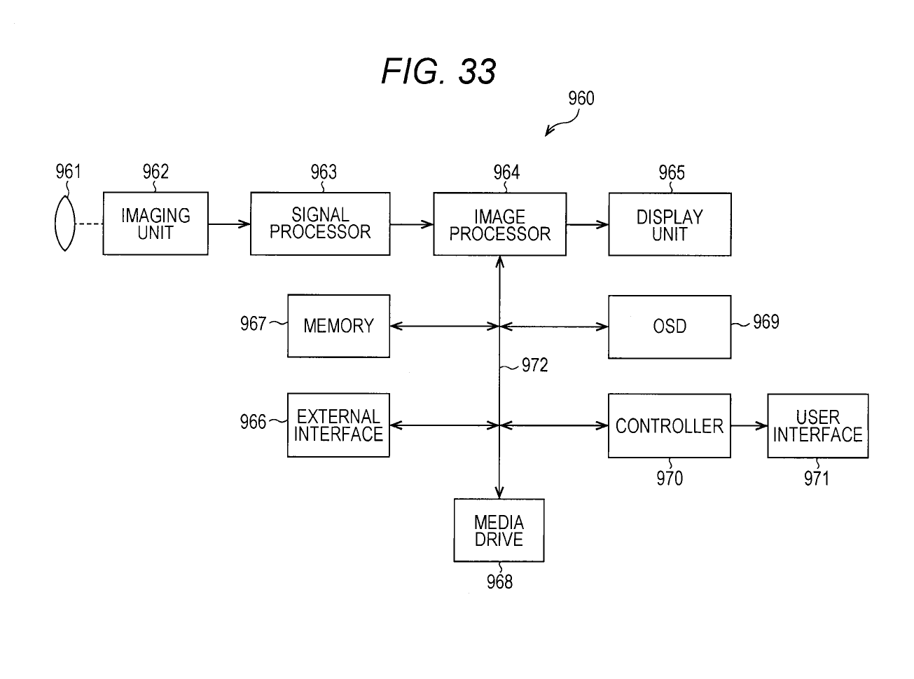

FIG. 33 illustrates an example of a schematic configuration of an imaging device to which the above-described embodiment is applied. An imaging device 960 images an object to generate the image, encodes the image data, and records the same on a recording medium.

The imaging device 960 includes an optical block 961, an imaging unit 962, a signal processor 963, an image processor 964, a display unit 965, an external interface 966, a memory 967, a media drive 968, an OSD 969, a controller 970, a user interface 971, and a bus 972.

The optical block 961 is connected to the imaging unit 962. The imaging unit 962 is connected to the signal processor 963. The display unit 965 is connected to the image processor 964. The user interface 971 is connected to the controller 970. The bus 972 connects the image processor 964, the external interface 966, the memory 967, the media drive 968, the OSD 969, and the controller 970 to one another.

The optical block 961 includes a focus lens, a diaphragm mechanism, and the like. The optical block 961 forms an optical image of the object on an imaging surface of the imaging unit 962. The imaging unit 962 includes an image sensor such as a CCD (charge coupled device) and a CMOS (complementary metal oxide semiconductor) and converts the optical image formed on the imaging surface to an image signal as an electric signal by photoelectric conversion. Then, the imaging unit 962 outputs the image signal to the signal processor 963.

The signal processor 963 performs various camera signal processes such as knee correction, gamma correction, and color correction to the image signal input from the imaging unit 962. The signal processor 963 outputs the image data after the camera signal process to the image processor 964.

The image processor 964 encodes the image data input from the signal processor 963 to generate the encoded data. Then, the image processor 964 outputs the generated encoded data to the external interface 966 or the media drive 968. Moreover, the image processor 964 decodes the encoded data input from the external interface 966 or the media drive 968 to generate the image data. Then, the image processor 964 outputs the generated image data to the display unit 965. The image processor 964 may also output the image data input from the signal processor 963 to the display unit 965 to display the image. The image processor 964 may also superimpose data for display obtained from the OSD 969 on the image output to the display unit 965.

The OSD 969 generates the GUI image such as the menu, the button, and the cursor, for example, and outputs the generated image to the image processor 964.

The external interface 966 is configured as an USB input/output terminal, for example. The external interface 966 connects the imaging device 960 and a printer when printing the image, for example. Moreover, a drive is connected to the external interface 966 as necessary. The removable medium such as the magnetic disc and the optical disc is mounted on the drive, for example, and the program read from the removable medium may be installed on the imaging device 960. Further, the external interface 966 may be configured as a network interface connected to the network such as a LAN and the Internet. That is, the external interface 966 serves as the transmitting unit in the imaging device 960.

The recording medium mounted on the media drive 968 may be an arbitrary readable/writable removable medium such as the magnetic disc, the magneto-optical disc, the optical disc, and the semiconductor memory, for example. Moreover, the recording medium may be fixedly mounted on the media drive 968 to form a non-portable storage unit such as a built-in hard disk drive or SSD (Solid State Drive), for example.

The controller 970 includes the processor such as the CPU and the memory such as the RAM and the ROM. The memory stores the program executed by the CPU, the program data and the like. The program stored in the memory is read by the CPU at startup of the imaging device 960 to be executed, for example. The CPU controls operation of the imaging device 960 according to the operation signal input from the user interface 971, for example, by executing the program.

The user interface 971 is connected to the controller 970. The user interface 971 includes a button, a switch and the like for the user to operate the imaging device 960, for example. The user interface 971 detects the operation by the user via the components to generate the operation signal and outputs the generated operation signal to the controller 970.

In the imaging device 960 configured in this manner, the image processor 964 has the functions of the image encoding device and the image decoding device according to the above-described embodiment. Therefore, when images are encoded and decoded in the imaging device 960, the encoding efficiency can be improved.

In the present specification, an example in which various types of information such as a prediction mode, a code number of a predictive motion vector, differential motion vector information, and differential quantization parameter information are multiplexed into encoded streams and are transmitted from the encoding side to the decoding side has been described. However, a method of transmitting these items of information is not limited to this example. For example, these items of information may be transmitted or recorded as separate data associated with the encoded bit stream rather than being multiplexed into the encoded bit stream. Here, the term “associate” means that the image (or part of the image such as a slice and a block) included in the bit stream and information corresponding to the image can be linked with each other at the time of decoding. That is, the information may be transmitted on a transmission line other than that of the image (or bit stream). Moreover, the information may be recorded on another recording medium (or another recording area of the same recording medium) other than that of the image (or bit stream). Further, the information and the image (or bit stream) may be associated with each other in optional units such as a plurality of frames, one frame, or a part of the frame, for example.

While preferred embodiments of this disclosure have been described in detail with reference to the accompanying drawings, this disclosure is not limited to the embodiments. Those skilled in the art will readily appreciate that various modifications and changes may be made in the embodiment without departing from the technical spirit as described in the claims. Accordingly, all such modifications and changes are intended to be included within the scope of this disclosure as defined in the claims.

This technique may take the following configurations.

(1) An image processing device including: a predictive motion vector generating unit that generates a predictive motion vector used when decoding a motion vector of a current region using a motion vector of a neighboring region located around the current region; a predictive quantization parameter generating unit that generates a predictive quantization parameter used when decoding a quantization parameter of the current region according to a method of predicting the predictive motion vector of the neighboring region, generated by the predictive motion vector generating unit; and a parameter decoding unit that decodes the motion vector of the current region using the predictive motion vector of the current region generated by the predictive motion vector generating unit and decodes the quantization parameter of the current region using the predictive quantization parameter of the current region generated by the predictive quantization parameter generating unit.

(2) The image processing device according to (1), wherein the predictive quantization parameter generating unit generates the predictive quantization parameter of the current region depending on whether the method of predicting the predictive motion vector of the neighboring region is spatial prediction or temporal prediction.

(3) The image processing device according to (1) or (2), wherein the predictive quantization parameter generating unit generates the predictive quantization parameter of the current region depending on whether a position of a reference region referred to for the spatial prediction is TOP or Left when the method of predicting the predictive motion vector of the neighboring region is spatial prediction.

(4) The image processing device according to any one of (1) to (3), wherein the predictive quantization parameter generating unit generates the predictive quantization parameter of the current region using the predictive quantization parameter of the neighboring region generated according to the same prediction method as the prediction method of predicting the predictive motion vector of the current region.

(5) The image processing device according to any one of (1) and (4), wherein, when the region is made up of a plurality of sub-regions, the predictive quantization parameter generating unit generates, as a target of the adjacent region, the predictive quantization parameter of the current region using a predictive motion vector of a sub-region of the neighboring region, located adjacent to a top-left sub-region located at a top left corner of the current region.

(6) The image processing device according to any one of (1) to (4), wherein, when the region is made up of a plurality of sub-regions, the predictive quantization parameter generating unit generates, as a target of the adjacent region, the predictive quantization parameter of the current region using a predictive motion vector of a top sub-region of the neighboring region, located adjacent to the top of the current region and a predictive motion vector of a left sub-region of the neighboring region, located adjacent to the left of the current region.

(7) The image processing device according to any one of (1) to (6), wherein, when bi-predictive prediction is applied to the neighboring region, the predictive quantization parameter generating unit generates the predictive quantization parameter of the current region according to a method of predicting a predictive motion vector with respect to List0 prediction, of the neighboring region.

(8) The image processing device according to any one of (1) to (6), wherein, when bi-predictive prediction is applied to the neighboring region, the predictive quantization parameter generating unit generates the predictive quantization parameter of the current region according to a method of predicting a predictive motion vector with respect to a List0 prediction, of the neighboring region when a current picture is not reordered and generates the predictive quantization parameter of the current region according to a method of predicting a predictive motion vector with respect to List1 prediction, of the neighboring region when the current picture is reordered.

(9) The image processing device according to any one of (1) to (6), wherein when bi-predictive prediction is applied to the neighboring region, the predictive quantization parameter generating unit generates the predictive quantization parameter of the current region according to a method of predicting a predictive motion vector relating to prediction of a closer distance on a time axis, of the neighboring region.

(10) The image processing device according to any one of (1) to (6), wherein the predictive quantization parameter generating unit generates the predictive quantization parameter of the current region according to a prediction direction of the predictive motion vector of the neighboring region and a prediction direction of the predictive motion vector of the current region.

(11) The image processing device according to any one of (1) to (6), further including: a decoding unit that decodes a bit stream using the motion vector and the quantization parameter decoded by the parameter decoding unit.

(12) The image processing device according to any one of (1) to (6), wherein the bit stream is encoded in units having a layer structure and the decoding unit decodes the bit stream in units having a layer structure.

(13) An image processing method for causing an image processing device to execute: generating a predictive motion vector used when decoding a motion vector of a current region using a motion vector of a neighboring region located around the current region; generating a predictive quantization parameter used when decoding a quantization parameter of the current region according to a method of predicting the generated predictive motion vector of the neighboring region; and decoding the motion vector of the current region using the generated predictive motion vector of the current region and decoding the quantization parameter of the current region using the generated predictive quantization parameter of the current region.

(14) An image processing device including: a predictive motion vector generating unit that generates a predictive motion vector used when encoding a motion vector of a current region using a motion vector of a neighboring region located around the current region; a predictive quantization parameter generating unit that generates a predictive quantization parameter used when encoding a quantization parameter of the current region according to a method of predicting the predictive motion vector of the neighboring region, generated by the predictive motion vector generating unit; and a parameter encoding unit that encodes the motion vector of the current region using the predictive motion vector of the current region generated by the predictive motion vector generating unit and encodes the quantization parameter of the current region using the predictive quantization parameter of the current region generated by the predictive quantization parameter generating unit.

(15) The image processing device according to (14), wherein the predictive quantization parameter generating unit generates the predictive quantization parameter of the current region depending on whether the method of predicting the predictive motion vector of the neighboring region is spatial prediction or temporal prediction.

(16) The image processing device according to (14) or (15), wherein the predictive quantization parameter generating unit generates the predictive quantization parameter of the current region using the predictive quantization parameter of the neighboring region generated according to the same prediction method as the prediction method of predicting the predictive motion vector of the current region.

(17) The image processing device according to any one of (12) to (15), wherein the predictive quantization parameter generating unit generates the predictive quantization parameter of the target region according to a prediction direction of the predictive motion vector of the neighboring region and a prediction direction of the predictive motion vector of the target region.

(18) The image processing device according to any one of (14) to (17), further including: an encoding unit that encodes an image using the motion vector of the current region and the quantization parameter of the current region to generate a bit stream; and a transmission unit that transmits the motion vector and the quantization parameter encoded by the parameter encoding unit together with the bit stream generated by the encoding unit.

(19) The image processing device according to (18), wherein the bit stream is encoded in units having a layer structure, and the encoding unit encodes the image in units having a layer structure to generate the bit stream.

(20) An image processing method for causing an image processing device to execute: generating a predictive motion vector used when encoding a motion vector of a current region using a motion vector of a neighboring region located around the current region; generating a predictive quantization parameter used when encoding a quantization parameter of the current region according to a method of predicting the generated predictive motion vector of the neighboring region; and encoding the motion vector of the current region using the generated predictive motion vector of the current region and encoding the quantization parameter of the target region using the generated predictive quantization parameter of the current region.

### REFERENCE SIGNS LIST

100: Image encoding device
105: Quantization unit
106: Lossless encoding unit
115: Motion prediction/compensation unit
121: Motion vector encoding unit
122: Region determining unit
151: Adjacent motion vector buffer
152: Candidate predictive motion vector generating unit
153: Cost function value calculating unit
154: Optimal predictive motion vector determining unit
161: Region deciding unit
162: Adjacent predictive motion vector
171: Quantizer
172: Differential QP generating unit
173: Adjacent QP buffer
174: Predictive QP generating unit
200: Image decoding device
202: Lossless decoding unit
203: Inverse quantization unit
212: Motion prediction/compensation unit
221: Motion vector decoding unit
222: Region determining unit
251: Predictive motion vector information buffer
252: Differential motion vector information buffer
253: Predictive motion vector reconstructing unit
254: Motion vector reconstructing unit
255: Adjacent motion vector buffer
261: Region deciding unit
262: Adjacent predictive motion vector buffer
271: Predictive QP generating unit
272: Adjacent QP buffer
273: Differential QP buffer
274: Current QP reconstructing unit
275: Inverse quantizer

1. An image processing device comprising:
a predictive motion vector generating unit that generates a predictive motion vector used when decoding a motion vector of a current region using a motion vector of a neighboring region located around the current region;
a predictive quantization parameter generating unit that generates a predictive quantization parameter used when decoding a quantization parameter of the current region according to a method of predicting the predictive motion vector of the neighboring region, generated by the predictive motion vector generating unit; and
a parameter decoding unit that decodes the motion vector of the current region using the predictive motion vector of the current region generated by the predictive motion vector generating unit and decodes the quantization parameter of the current region using the predictive quantization parameter of the current region generated by the predictive quantization parameter generating unit.

2. The image processing device according to claim 1, wherein
the predictive quantization parameter generating unit generates the predictive quantization parameter of the current region depending on whether the method of predicting the predictive motion vector of the neighboring region is spatial prediction or temporal prediction.

3. The image processing device according to claim 2, wherein
the predictive quantization parameter generating unit generates the predictive quantization parameter of the current region depending on whether a position of a reference region referred to for the spatial prediction is TOP or Left when the method of predicting the predictive motion vector of the neighboring region is spatial prediction.

4. The image processing device according to claim 2, wherein
the predictive quantization parameter generating unit generates the predictive quantization parameter of the current region using the predictive quantization parameter of the neighboring region generated according to the same prediction method as the prediction method of predicting the predictive motion vector of the current region.

5. The image processing device according to claim 2, wherein
when the region is made up of a plurality of sub-regions, the predictive quantization parameter generating unit generates, as a target of the adjacent region, the predictive quantization parameter of the current region using a predictive motion vector of a sub-region of the neighboring region, located adjacent to a top-left sub-region located at a top left corner of the current region.

6. The image processing device according to claim 2, wherein
when the region is made up of a plurality of sub-regions, the predictive quantization parameter generating unit generates, as a target of the adjacent region, the predictive quantization parameter of the current region using a predictive motion vector of a top sub-region of the neighboring region, located adjacent to the top of the current region and a predictive motion vector of a left sub-region of the neighboring region, located adjacent to the left of the current region.

7. The image processing device according to claim 2, wherein
when bi-predictive prediction is applied to the neighboring region, the predictive quantization parameter generating unit generates the predictive quantization parameter of the current region according to a method of predicting a predictive motion vector with respect to List0 prediction, of the neighboring region.

8. The image processing device according to claim 2, wherein
when bi-predictive prediction is applied to the neighboring region, the predictive quantization parameter generating unit generates the predictive quantization parameter of the current region according to a method of predicting a predictive motion vector with respect to a List0 prediction, of the neighboring region when a current picture is not reordered and generates the predictive quantization parameter of the current region according to a method of predicting a predictive motion vector with respect to List1 prediction, of the neighboring region when the current picture is reordered.

9. The image processing device according to claim 2, wherein
when bi-predictive prediction is applied to the neighboring region, the predictive quantization parameter generating unit generates the predictive quantization parameter of the current region according to a method of predicting a predictive motion vector with respect to prediction of a closer distance on a time axis, of the neighboring region.

10. The image processing device according to claim 2, wherein
the predictive quantization parameter generating unit generates the predictive quantization parameter of the current region according to a prediction direction of the predictive motion vector of the neighboring region and a prediction direction of the predictive motion vector of the current region.

11. The image processing device according to claim 1, further comprising:
a decoding unit that decodes a bit stream using the motion vector and the quantization parameter decoded by the parameter decoding unit.

12. The image processing device according to claim 11, wherein
the bit stream is encoded in units having a layer structure and the decoding unit decodes the bit stream in units having a layer structure.

13. An image processing method for causing an image processing device to execute:
generating a predictive motion vector used when decoding a motion vector of a current region using a motion vector of a neighboring region located around the current region;
generating a predictive quantization parameter used when decoding a quantization parameter of the current region according to a method of predicting the generated predictive motion vector of the neighboring region; and
decoding the motion vector of the current region using the generated predictive motion vector of the current region and decoding the quantization parameter of the current region using the generated predictive quantization parameter of the current region.

14. An image processing device comprising:
a predictive motion vector generating unit that generates a predictive motion vector used when encoding a motion vector of a current region using a motion vector of a neighboring region located around the current region;
a predictive quantization parameter generating unit that generates a predictive quantization parameter used when encoding a quantization parameter of the current region according to a method of predicting the predictive motion vector of the neighboring region, generated by the predictive motion vector generating unit; and
a parameter encoding unit that encodes the motion vector of the current region using the predictive motion vector of the current region generated by the predictive motion vector generating unit and encodes the quantization parameter of the current region using the predictive quantization parameter of the current region generated by the predictive quantization parameter generating unit.

15. The image processing device according to claim 14, wherein
the predictive quantization parameter generating unit generates the predictive quantization parameter of the current region depending on whether the method of predicting the predictive motion vector of the neighboring region is spatial prediction or temporal prediction.

16. The image processing device according to claim 15, wherein
the predictive quantization parameter generating unit generates the predictive quantization parameter of the current region using the predictive quantization parameter of the neighboring region generated according to the same prediction method as the prediction method of predicting the predictive motion vector of the current region.

17. The image processing device according to claim 15, wherein
the predictive quantization parameter generating unit generates the predictive quantization parameter of the target region according to a prediction direction of the predictive motion vector of the neighboring region and a prediction direction of the predictive motion vector of the target region.

18. The image processing device according to claim 14, further comprising:
an encoding unit that encodes an image using the motion vector of the current region and the quantization parameter of the current region to generate a bit stream; and
a transmission unit that transmits the motion vector and the quantization parameter encoded by the parameter encoding unit together with the bit stream generated by the encoding unit.

19. The image processing device according to claim 18, wherein
the encoding unit encodes the image in units having a layer structure to generate the bit stream.

20. An image processing method for causing an image processing device to execute:
generating a predictive motion vector used when encoding a motion vector of a current region using a motion vector of a neighboring region located around the current region;
generating a predictive quantization parameter used when encoding a quantization parameter of the current region according to a method of predicting the generated predictive motion vector of the neighboring region; and
encoding the motion vector of the current region using the generated predictive motion vector of the current region and encoding the quantization parameter of the target region using the generated predictive quantization parameter of the current region.
